(19) United States
(12) Patent Application Publication
(10) Pub. No.: US 2023/0250246 A1
(43) Pub. Date: Aug. 10, 2023

(54) High Clarity Water-Soluble Films and Methods of Making Same

(71) Applicant: MONOSOL, LLC, Merrillville, IN (US)

(72) Inventors: Mark Sovereign, Merrillville, IN (US); Shigeng Li, Naperville, IL (US)

(21) Appl. No.: 18/164,558

(22) Filed: Feb. 3, 2023

Related U.S. Application Data
(60) Provisional application No. 63/267,587, filed on Feb. 4, 2022.

(51) Int. Cl. C08J 5/18; C08K 5/00

(52) U.S. Cl. CPC C08J 5/18; C08K 5/0016; C08J 2329/04; C08J 2303/02

(57) ABSTRACT

The disclosure provides a water-soluble film comprising a polyvinyl alcohol resin comprising a blend of polyvinyl alcohol polymers, a starch, and a plasticizer, wherein the water-soluble film is characterized by a matte to gloss coefficient of friction (COF) in a range of about 0.05 to about 3.0 and a haze at 100% strain in a range of about 0.5% to about 40%, and methods of preparing same.

### CROSS-REFERENCE TO RELATED APPLICATIONS

This application claims the benefit under 35 USC 119(e) of U.S. Provisional Application No. 63/267,587, filed Feb. 4, 2022, the entire disclosure of which is hereby incorporated by reference.

### FIELD

The present disclosure relates generally to water-soluble films and related articles. More particularly, the disclosure relates to water-soluble films that have high clarity

### BACKGROUND

Water-soluble polymeric films are commonly used as packaging materials to simplify dispersing, pouring, dissolving and dosing of a material to be delivered. Advantageously, this provides for accurate dosing while eliminating the need for the user to measure the composition. The pouched composition may also reduce mess that would be associated with dispensing a similar composition from a vessel, such as pouring a composition from a bottle. In sum, soluble pre-measured polymeric film pouches provide for convenience in a variety of applications.

Some commercially available water-soluble films can have a hazy appearance, particularly after stretching, for example, upon formation of a pouch for enclosing a unit dose composition. Such films that have a hazy appearance can be viewed unfavorably by consumers. Current options for high clarity films generally include films including polyvinyl alcohol copolymer resins which can increase the cost of making and using the clear films. Accordingly, there is a need in the art to provide a cost effective high clarity film.

### SUMMARY

One aspect of the disclosure provides a water-soluble film including a water-soluble mixture of a polyvinyl alcohol resin including a first polyvinyl alcohol homopolymer having a viscosity in a range of about 16 cP to about 35 cP and a second polyvinyl alcohol homopolymer having a viscosity in a range of about 5 cP to about 15 cP, wherein the first polyvinyl alcohol homopolymer is present in an amount in a range of about 60% to about 85% by weight, based on the total weight of the polyvinyl alcohol resin and the second polyvinyl alcohol homopolymer is present in an amount in a range of about 15% to about 40% by weight, based on the total weight of the polyvinyl alcohol resin, a starch present in an amount in a range of about 0.2 to about 3.0 part by weight based on 100 parts polyvinyl alcohol resin (PHR), and a plasticizer present in an amount in a range of about 15 to about 35 PHR, and the water-soluble film is characterized by a matte to gloss coefficient of friction (COF) in a range of about 0.05 to about 3.0 as determined according to the Coefficient of Friction Test; and a haze at 100% strain in a range of about 0.5% to about 70% as determined according to the Haze Test.

Another aspect of the disclosure provides a method of preparing a water-soluble film of the disclosure, the method including the steps of casting onto a surface the water-soluble mixture of the disclosure, wherein the surface is characterized by a gloss unit (GU) value at an angle of 60° in a range of about 150 GU to about 550 GU.

Another aspect of the disclosure provides a water-soluble film including a water-soluble mixture of a polyvinyl alcohol resin including a polyvinyl alcohol homopolymer having a viscosity in a range of about 5 cP to about 35 cP and a polyvinyl alcohol copolymer having an anionic monomer unit, wherein the polyvinyl alcohol homopolymer is present in an amount in a range of about 25% to about 75% by weight, based on the total weight of the polyvinyl alcohol resin and the polyvinyl alcohol copolymer is present in an amount in a range of about 75% to about 25% by weight, based on the total weight of the polyvinyl alcohol resin, a starch present in an amount in a range of about 0.2 to about 6.0 part by weight based on 100 parts polyvinyl alcohol resin (PHR), and a plasticizer present in an amount in a range of about 15 to about 35 PHR, and the water-soluble film is characterized by a matte to gloss coefficient of friction (COF) in a range of about 0.05 to about 3.0 as determined according to the Coefficient of Friction Test; and a haze at 100% strain in a range of about 0.5% to about 40% as determined according to the Haze Test.

The disclosure further provides a water-soluble film including a water-soluble mixture of a polyvinyl alcohol resin including a first polyvinyl alcohol copolymer having an anionic monomer unit selected from the group of maleic acid, monoalkyl maleate, dialkyl maleate, maleic anhydride, and alkali metal salts thereof, and a second polyvinyl alcohol copolymer having an anionic monomer unit selected from the group of alkyl acrylates, such as methyl acrylate, wherein the first polyvinyl alcohol copolymer is present in an amount in a range of about 1% to about 50% by weight, based on the total weight of the polyvinyl alcohol resin and the second polyvinyl alcohol copolymer is present in an amount in a range of about 50% to about 99% by weight, based on the total weight of the polyvinyl alcohol resin, a starch present in an amount in a range of about 0.2 to about 3.0 part by weight based on 100 parts polyvinyl alcohol resin (PHR), and a plasticizer present in an amount in a range of about 15 to about 35 PHR, and the water-soluble film is characterized by a matte to gloss coefficient of friction (COF) in a range of about 0.05 to about 3.0 as determined according to the Coefficient of Friction Test; and a haze at 100% strain in a range of about 0.5% to about 40% as determined according to the Haze Test.

For the compositions and methods described herein, optional features, including but not limited to components, compositional ranges thereof, substituents, conditions, and steps are contemplated to be selected from the various aspects, embodiments, and examples provided herein.

Further aspects and advantages will be apparent to those of ordinary skill in the art from a review of the following detailed description, taken in conjunction with the drawings. While the film, article, pouch, and their methods of making and use are capable of taking on various forms, the description hereafter includes specific embodiments with the understanding that the disclosure is illustrative, and is not intended to limit the invention to the specific embodiments described herein.

### BRIEF DESCRIPTION OF THE DRAWINGS

For further facilitating the understanding of the present invention, two drawing figures are appended hereto.

FIG. 1 shows an example of an apparatus for measuring the coefficient of friction of a film specimen.

FIG. 2A demonstrates the clarity of a clear film of the disclosure relative to a commercially available “clear” film in a non-stretched state.

FIG. 2B demonstrates the clarity of a clear film of the disclosure relative to a commercially available “clear” film in a stretched state

### DETAILED DESCRIPTION

The disclosure provides water-soluble films having high clarity and low tendencies to be “self-sticking”, e.g., when provided as a roll of water soluble film or when the film is used to form a pouch containing a composition and packaged together with other pouches in a secondary package. In general, clarity and the tendency of a film to stick to itself are competing properties. Without intending to be bound by theory, it is believed that the smoother a film surface is, the less likely the film is to scatter incident light, and the more transparent/clear the film will be. In contrast, a film having fewer surface irregularities will have the more surface area available to rub against another portion of the film, and effect sticking between the film surfaces. To decrease the likelihood of a water-soluble film sticking to itself in a roll or otherwise, antiblocking agents are typically included in the water-soluble film. The films of the disclosure can demonstrate the beneficial properties of high clarity and low tendencies to self-stick, while being substantially free of an antiblocking agent, thereby providing a film with little to no inorganic components, and reducing processing complexities. The disclosure further provides a method of preparing the high clarity films of the disclosure comprising solution casting a water-soluble mixture on a surface characterized by a gloss unit (GU) value at an angle of 60° of at least about 150 GU to about 550 GU.

The water-soluble films of the disclosure advantageously are high clarity films. As used herein, the term “clarity” refers generally to the overall visual appearance of the film. In general, clarity and haze are inversely related and as the haze value of a film decreases, the clarity of a film increases. As used herein, the term “haze” refers to the amount of light scattered as it passes through the film.

The water-soluble films described herein and pouches prepared therefrom, surprisingly provides one or more benefits, including but not limited to (a) a haze value at 100% strain of about 40% or less as determined to the Haze test disclosed herein; and/or (b) a matte to gloss coefficient of static of about 0.6 or less as determined by the Coefficient of Friction Test disclosed herein; and/or (c) a blocking value of about 3 N or less as determined for a full film roll in accordance with the Blocking Test disclosed herein; and/or (d) an elongation at break of at least 350% as determined in accordance with the Elongation Test disclosed herein; and/or (e) a tensile strength of at least about 40 MPa as determined in accordance with the Tensile Test disclosed herein. In embodiments, the film of the disclosure and pouches prepared therefrom demonstrate at least benefits (a) described above. In some embodiments, the film of the disclosure and pouches prepared therefrom demonstrate at least benefit (b) described above. In some embodiments, the film of the disclosure and pouches prepared therefrom demonstrate each of benefits (a) and (b). In some embodiments, the film of the disclosure and pouches prepared therefrom demonstrate each of benefits (a), (b), and (c). In some embodiments, the film of the disclosure and pouches prepared therefrom demonstrate each of benefits (a), (b), (c), and (d). In some embodiments, the film of the disclosure and pouches prepared therefrom demonstrate each of benefits (a), (b), (c), (d), and (e).

The disclosure provides a water-soluble film including a water-soluble mixture of a polyvinyl alcohol resin including a first polyvinyl alcohol homopolymer having a viscosity in a range of about 16 cP to about 35 cP and a second polyvinyl alcohol homopolymer having a viscosity in a range of about 5 cP to about 15 cP, wherein the first polyvinyl alcohol homopolymer is present in an amount in a range of about 60% to about 85% by weight, based on the total weight of the polyvinyl alcohol resin and the second polyvinyl alcohol homopolymer is present in an amount in a range of about 15% to about 40% by weight, based on the total weight of the polyvinyl alcohol resin, a starch present in an amount in a range of about 0.2 to about 6.0 part by weight based on 100 parts polyvinyl alcohol resin (PHR), and a plasticizer present in an amount in a range of about 15 to about 35 PHR, and the water-soluble film is characterized by a matte to gloss coefficient of friction (COF) in a range of about 0.05 to about 3.0 as determined according to the Coefficient of Friction Test; and a haze at 100% strain in a range of about 0.5% to about 40% as determined according to the Haze Test.

“Comprising” as used herein means that various components, ingredients or steps that can be conjointly employed in practicing the present disclosure. Accordingly, the term “comprising” encompasses the more restrictive terms “consisting essentially of” and “consisting of.” The present compositions can comprise, consist essentially of, or consist of any of the required and optional elements disclosed herein. For example, a packet can “consist essentially of” a film described herein, while including a secondary film (e.g., lid portion), and optional markings on the film, e.g. by inkjet printing. The invention illustratively disclosed herein suitably may be practiced in the absence of any element or step which is not specifically disclosed herein.

Films, such as those made in accordance with the disclosure, are defined by the polymer industry (Encyclopedia of Polymer Science and Technology, John Wiley & Sons, Inc., 1967, Vol. 6, page 764) as “shaped plastics that are comparatively thin in relation to their breadth and width and have a maximum thickness of 0.010 in.”

Self-supporting films are those capable of supporting their own weight. Uniform films refer to those which are virtually free of breaks, tears, holes, bubbles, and striations.

To be considered a water-soluble film according to the present disclosure, the film, at a thickness of about 1.5 mil (about 0.038 mm), dissolves in 300 seconds or less in water at a temperature of 20° C. (68° F.) in accordance with MonoSol Test Method MSTM-205.

As used herein, the terms “packet(s)” and “pouch(es)” should be considered interchangeable. In certain embodiments, the terms packet(s) and pouch(es), respectively, are used to refer to a container made using the film and a sealed container preferably having a material sealed therein, e.g., in the form of a measured dose delivery system. The sealed pouches can be made from any suitable method, including such processes and features such as heat sealing, solvent welding (sealing), and adhesive sealing (e.g., with use of a water-soluble adhesive).

All percentages, parts and ratios are based upon the total dry weight of the formed film composition and all measurements are made at about 25° C., unless otherwise specified. All such weights as they pertain to listed ingredients are based on the active level and therefore do not include carriers or by-products that may be included in commercially available materials, unless otherwise specified.

All ranges set forth herein include all possible subsets of ranges and any combinations of such subset ranges. By default, ranges are inclusive of the stated endpoints, unless stated otherwise. Where a range of values is provided, it is understood that each intervening value between the upper and lower limit of that range and any other stated or intervening value in that stated range, is encompassed within the disclosure. The upper and lower limits of these smaller ranges may independently be included in the smaller ranges, and are also encompassed within the disclosure, subject to any specifically excluded limit in the stated range. Where the stated range includes one or both of the limits, ranges excluding either or both of those included limits are also contemplated to be part of the disclosure.

The dimensions and values disclosed herein are not to be understood as being strictly limited to the exact numerical values recited. Instead, unless otherwise specified, each such dimension is intended to include both the recited value and a functionally equivalent range surrounding that value. For example, a dimension disclosed as “15 mm” is intended to include “about 15 mm,” and “about 15 mm” can include a range of from 14.5 mm to 15.4 mm, e.g. by numerical rounding.

As used herein and unless specified otherwise, the terms “wt. %” and “wt %” are intended to refer to the composition of the identified elements in “dry” (non water) parts by weight of the entire film (when applicable) or parts by weight of the entire composition enclosed within a pouch (when applicable). As used herein and unless specified otherwise, the term “PHR” is intended to refer to the composition of the identified element in parts per one hundred parts water-soluble polymer (or resin; whether polyvinyl alcohol or otherwise) in the water-soluble film.

The film can be made by a solution casting method. The film can be used to form an article or a pouch by any suitable process, including thermoforming and, for example, solvent sealing or heat sealing of film layers around a periphery of the article. The pouches can be used for dosing materials to be delivered into bulk water, for example.

The disclosure further provides a water-soluble film including a water-soluble mixture of a polyvinyl alcohol resin including a polyvinyl alcohol homopolymer having a viscosity in a range of about 5 cP to about 35 cP and a polyvinyl alcohol copolymer having an anionic monomer unit, wherein the polyvinyl alcohol homopolymer is present in an amount in a range of about 25% to about 75% by weight, based on the total weight of the polyvinyl alcohol resin and the polyvinyl alcohol copolymer is present in an amount in a range of about 75% to about 25% by weight, based on the total weight of the polyvinyl alcohol resin, a starch present in an amount in a range of about 0.2 to about 6.0 part by weight based on 100 parts polyvinyl alcohol resin (PHR), and a plasticizer present in an amount in a range of about 15 to about 35 PHR, and the water-soluble film is characterized by a matte to gloss coefficient of friction (COF) in a range of about 0.05 to about 3.0 as determined according to the Coefficient of Friction Test; and a haze at 100% strain in a range of about 0.5% to about 40% as determined according to the Haze Test.

The disclosure further provides a water-soluble film including a water-soluble mixture of a polyvinyl alcohol resin including a first polyvinyl alcohol copolymer having an anionic monomer unit selected from the group of maleic acid, monoalkyl maleate, dialkyl maleate, maleic anhydride, and alkali metal salts thereof and a second polyvinyl alcohol copolymer having an anionic monomer unit selected from the group of alkyl acrylates such as methyl acrylate, wherein the first polyvinyl alcohol copolymer is present in an amount in a range of about 1% to about 50% by weight, based on the total weight of the polyvinyl alcohol resin and the second polyvinyl alcohol copolymer is present in an amount in a range of about 50% to about 99% by weight, based on the total weight of the polyvinyl alcohol resin, a starch present in an amount in a range of about 0.2 to about 3.0 part by weight based on 100 parts polyvinyl alcohol resin (PHR), and a plasticizer present in an amount in a range of about 15 to about 35 PHR, and the water-soluble film is characterized by a matte to gloss coefficient of friction (COF) in a range of about 0.05 to about 3.0 as determined according to the Coefficient of Friction Test; and a haze at 100% strain in a range of about 0.5% to about 40% as determined according to the Haze Test.

The films, articles, pouches, and related methods of making and use are contemplated to include embodiments including any combination of one or more of the elements, features, and steps further described below (including those shown in the Examples and figures), unless stated otherwise.

### Water-Soluble Films

The film and related articles and pouches described herein can comprise a plasticized, water soluble film. The water soluble film can be solution cast. The films optionally further include one or more additives selected from fillers, surfactants, anti-block agents, antioxidants, antifoams, bleaching agents, aversive agents, pungents, other functional ingredients, and combinations of the foregoing. In one aspect, the water soluble film can comprise a total of at least about 50 wt % of a polyvinyl alcohol (PVOH) resin comprising one or more PVOH polymers. In embodiments, the water-soluble film can comprise a total of at least about 55 wt %, about 60 wt %, about 65 wt %, about 70 wt %, about 75 wt %, about 80 wt %, about 85 wt %, about 90 wt %, or about 95 wt % of a PVOH resin comprising one or more PVOH polymers, based on the total weight of the film, for example, in a range of about 55 wt % to about 95 wt %, about 60 wt % to about 90 wt %, or about 65 wt % to about 85 wt %, or about 70 wt % to about 80 wt %.

The film can have any suitable thickness, and film thicknesses of about 76 microns (μm) or 88 microns are typical and particularly contemplated. Other values and ranges contemplated include values in a range of about 5 to about 200 μm, or in a range of about 20 to about 100 μm, or about 60 to about 120 μm, or about 70 to about 100 μm, or about 40 to about 90 μm, or about 50 to about 80 μm, or about 60 to about 65 μm, or about 20 to about 60 μm, or about 20 to about 50 μm, or about 30 to about 40 μm, for example about 35 μm, about 36 μm, about 50 μm, about 65 μm, about 76 μm, about 88 μm, or about 90 μm.

### PVOH Resins

The film described herein can include one or more polyvinyl alcohol (PVOH) polymers to make up the PVOH resin content of the film.

Polyvinyl alcohol is a synthetic resin generally prepared by the alcoholysis, usually termed hydrolysis or saponification, of polyvinyl acetate. Fully hydrolyzed PVOH, where virtually all the acetate groups have been converted to alcohol groups, is a strongly hydrogen-bonded, highly crystalline polymer which dissolves only in hot water—greater than about 140° F. (about 60° C.). If a sufficient number of acetate groups are allowed to remain after the hydrolysis of polyvinyl acetate, that is, the PVOH polymer is partially hydrolyzed, then the polymer is more weakly hydrogen-bonded, less crystalline, and is generally soluble in cold water—less than about 50° F. (about 10° C.). As such, the partially hydrolyzed polymer is a vinyl alcohol-vinyl acetate copolymer that is a PVOH copolymer, but is commonly referred to as one or more of homopolymeric PVOH, PVOH homopolymer, or oftentimes merely PVOH, as the presence of acetate constituents may be implied. As used herein, and unless specified otherwise, a “polyvinyl alcohol homopolymer” refers to a polyvinyl alcohol polymer that optionally includes vinyl acetate groups as a polymeric constituent.

In embodiments, the polyvinyl alcohol resin includes a blend of at least two polyvinyl alcohol homopolymers that differ in viscosity, degree of hydrolysis, or both. In embodiments, the polyvinyl alcohol resin includes a first polyvinyl alcohol homopolymer and a second polyvinyl alcohol homopolymer.

In some embodiments, the PVOH resin can include a partially or fully hydrolyzed PVOH copolymer that includes an anionic monomer unit, a vinyl alcohol monomer unit, and optionally a vinyl acetate monomer unit. In various embodiments, the anionic monomer unit can be one or more of vinyl acetic acid, alkyl acrylates, maleic acid, monoalkyl maleate, dialkyl maleate, monomethyl maleate, dimethyl maleate, maleic anhydride, fumaric acid, monoalkyl fumarate, dialkyl fumarate, monomethyl fumarate, dimethyl fumarate, itaconic acid, monomethyl itaconate, dimethyl itaconate, itaconic anhydride, citraconic acid, monoalkyl citraconate, dialkyl citraconate, citraconic anhydride, mesaconic acid, monoalkyl mesaconate, dialkyl mesaconate, glutaconic acid, monoalkyl glutaconate, dialkyl glutaconate, glutaconic anhydride, vinyl sulfonic acid, alkyl sulfonic acid, ethylene sulfonic acid, 2-acrylamido-1-methyl propane sulfonic acid, 2-acrylamide-2-methylpropanesulfonic acid, 2-methylacrylamido-2-methylpropanesulfonic acid, 2-sulfoethyl acrylate, alkali metal salts of the foregoing (e.g., sodium, potassium, or other alkali metal salts), esters of the foregoing (e.g., methyl, ethyl, or other C₁-C₄ or C₆ alkyl esters), and combinations of the foregoing (e.g., multiple types of anionic monomers or equivalent forms of the same anionic monomer). For example, the anionic monomer can include one or more of monomethyl maleate and alkali metal salts thereof (e.g. sodium salts).

In one type of embodiment, the PVOH is a carboxyl group modified copolymer. In another aspect, the PVOH can be modified with a dicarboxyl type monomer. In one class of these embodiments, the α carbon of the carbonyl is contacted to the unsaturated bond (e.g., maleic acid, fumaric acid). In another class of these embodiments, the α carbon of the carbonyl is contacted to the unsaturated bond with a methyl branch (e.g., citraconic acid, mesaconic acid). In another class of these embodiments, the β carbon of the carbonyl is contacted to the unsaturated bond (e.g., itaconic acid, cis-glutaconic acid, trans-glutaconic acid). Monomers that provide alkyl carboxyl groups are contemplated. A maleate type (e.g., dialkyl maleate, including monomethyl maleate) or itaconate type (i.e., itaconic acid) comonomer is particularly contemplated.

In certain carboxylate-containing PVOH copolymers, the carboxylate units, if converted to carboxylic acid groups, are readily able to form stable gamma-lactone ring moieties by cyclizing with adjacent hydroxyl groups. Specifically, such gamma-lactone ring formation occurs when the carboxylate-containing PVOH copolymers are in contact with liquid laundry detergent formulations. The chemical incompatibility derives from the acid-base equilibria that exist in the liquid laundry detergent formulations and are usually in the form of amine-fatty acid equilibria and/or amine-anionic surfactant acid equilibria. Even if the detergent formulation is at an alkaline pH by virtue of the presence of a molar excess of amine, exchangeable hydrogen ions are still available to react with the carboxylate groups of the PVOH copolymer. When this happens, carboxylic acid groups form and they in turn will readily react with adjacent hydroxyl groups to form intramolecular lactones if the lactones have stable five-membered (gamma) ring structures. Other liquid products too numerous to mention may present similar chemical incompatibilities. The solubility of the polymer and hence the film is markedly affected by this reaction to form lactones; complete insolubility can occur in some cases resulting in polymer residues being attached to objects dispersed in a liquid with the polymer/film (e.g., on items of clothing at the end of a wash cycle with a detergent pouch made of such film). In contrast, other carboxylate-containing PVOH copolymers may potentially form lactone ring moieties smaller than five-membered or larger than five-membered; however, these lactone moieties are unstable due to steric and/or entropic effects and, therefore, such copolymers do not demonstrate the same change in solubility in the presence of a laundry detergent as the carboxylate-containing PVOH copolymers that can form gamma-lactone ring moieties.

In embodiments, the polyvinyl alcohol resin comprises a polyvinyl alcohol-co-maleate polymer. In refinements of the foregoing embodiments, the polyvinyl alcohol-co-maleate polymer may include one or more monomer units selected from maleic acid, monoalkyl maleate, dialkyl maleate, maleic anhydride, and alkali metal salts thereof. The polyvinyl alcohol-co-maleate polymer may be a partially or fully hydrolyzed copolymer of polyvinyl acetate and maleic anhydride. In embodiments, the polyvinyl alcohol-co-maleate includes at least 1 mol % maleate modification and up to about 8 mol % maleate modification, for example, about 1.5 mol %, about 1.75 mol %, about 2 mol %, about 2.4 mol %, about 2.5 mol %, about 2.8 mol %, about 3 mol %, about 3.2 mol %, about 3.5 mol %, about 3.8 mol %, about 4 mol %, about 4.2 mol %, about 4.5 mol %, about 5 mol %, about 6 mol %, about 7 mol %, or about 8 mol %.

In embodiments, the polyvinyl alcohol resin comprises a polyvinyl alcohol-co-alkyl acrylate. In refinements of the foregoing embodiments, the polyvinyl alcohol-co-alkyl acrylate may include one or more methyl acrylate monomer units. The polyvinyl alcohol-co-alkyl acrylate polymer may be a partially or fully hydrolyzed copolymer of polyvinyl acetate and methyl acrylate. In embodiments, the polyvinyl alcohol-co-alkyl acrylate includes at least 1 mol % acrylate modification and up to about 8 mol % acrylate modification, for example, about 1.5 mol %, about 1.75 mol %, about 2 mol %, about 2.4 mol %, about 2.5 mol %, about 2.8 mol %, about 3 mol %, about 3.2 mol %, about 3.5 mol %, about 3.8 mol %, about 4 mol %, about 4.2 mol %, about 4.5 mol %, about 5 mol %, about 6 mol %, about 7 mol %, or about 8 mol %. In embodiments, the at least a portion of the acrylate modification is not in the form of a lactone ring, for example, at least 25%, at least 50%, at least 75%, at least 80%, at least 85%, or at least 90% of the acrylate modification is not in the form of a lactone ring.

The viscosity of a PVOH polymer (μ) is determined by measuring a freshly made solution using a Brookfield LV type viscometer with UL adapter as described in British Standard ENISO 15023-2:2006 Annex E Brookfield Test method. It is international practice to state the viscosity of 4% (w/v) aqueous polyvinyl alcohol solutions at 20° C. All viscosities specified herein in Centipoise (cP) should be understood to refer to the viscosity of 4% (w/v) aqueous polyvinyl alcohol solution at 20° C., unless specified otherwise. Similarly, when a resin is described as having (or not having) a particular viscosity, unless specified otherwise, it is intended that the specified viscosity is the average viscosity for the resin, which inherently has a corresponding molecular weight distribution.

Suitable PVOH resins, for use individually or in combinations, can have viscosities in a range of about 5 cP to about 35 cP, or about 5 cP to about 30 cP, or about 5 cP to about 27 cP, or about 5 cP to about 25 cP, or about 5 cP to about 15 cP, or about 5 cP to about 14 cP, or about 5 cP to about 12 cP, or about 5 cP to about 10 cP, or about 5 cP to about 7 cP, or about 5 cP to about 8 cP, or about 10 cP to about 15 cP, or about 16 cP to about 35 cP, or about 18 cP to about 35 cP, or about 18 cP to about 30 cP, or about 18 cP to about 27 cP, or about 18 cP to about 25 cP, or about 20 cP to about 25 cP, for example, 32 cP, or 26 cP, or 23.5 cP, or 21 cP, or 19 cP, or 16.5 cP, or 14 cP, or 6 cP. It is well known in the art that the viscosity of PVOH resins is correlated with the weight average molecular weight (M̅w) of the PVOH resin, and often the viscosity is used as a proxy for the M̅w. When referring to the viscosity of a PVOH resin comprising a PVOH polymer blend, the weighted natural log average viscosity (μ̅) is used. The μ̅ for a PVOH resin that comprises two or more PVOH polymers is calculated by the formula μ̅=e^{ΣW}^{ᵢ}^{·ln μ}^{ᵢ} where μᵢ is the viscosity for the respective PVOH polymers.

In embodiments wherein the film includes a blend of a first polyvinyl alcohol homopolymer and a second polyvinyl alcohol homompolymer, the first polyvinyl alcohol homopolymer can have a viscosity in a range of about 16 cP to about 35 cP, about 18 cP to about 35 cP, about 18 cP to about 30 cP, about 18 cP to about 27 cP, about 18 cP to about 25 cP, or about 20 cP to about 25 cP. In embodiments, the second polyvinyl alcohol homopolymer can have a viscosity in a range of about 5 cP to about 15 cP, about 5 cP to about 14 cP, about 5 cP to about 12 cP, about 5 cP to about 10 cP, about 5 cP to about 7 cP, about 5 cP to about 8 cP, or about 10 cP to about 15 cP. In embodiments, the first polyvinyl alcohol homopolymer can have a viscosity in a range of about 16 cP to about 35 cP and the second polyvinyl alcohol homopolymer can have a viscosity in a range of about 5 cP to about 15 cP. In embodiments, the first polyvinyl alcohol homopolymer can have a viscosity in a range of about 20 cP to about 25 cP and the second polyvinyl alcohol homopolymer can have a viscosity in a range of about 5 cP to about 7 cP.

In embodiments wherein the film includes a blend of a polyvinyl alcohol homopolymer and a polyvinyl alcohol copolymer, the polyvinyl alcohol homopolymer can have a viscosity in a range of about 5 cP to about 35 cP, about 5 cP to about 15 cP, about 5 cP to about 7 cP, about 18 cP to about 27 cP, or about 20 cP to about 25 cP. In embodiments, the polyvinyl alcohol homopolymer has a viscosity in a range of about 5 to about 7 cP. In embodiments, the polyvinyl alcohol copolymer can have a viscosity in a range of about 10 cP to about 30 cP, for example, about 12 cP to about 28 cP, about 14 cP to about 26 cP, about 16 cP to about 24 cP, or about 18 cP to about 22 cP. In embodiments, the polyvinyl alcohol copolymer can have a viscosity in a range of about 18 cP to about 22 cP.

In embodiments wherein the film includes a blend of a first polyvinyl alcohol copolymer and a second polyvinyl alcohol copolymer, the first polyvinyl alcohol copolymer can have a viscosity in a range of about 10 cP to about 30 cP, for example, about 10 cP to about 20 cP, about 12 cP to about 19 cP, about 14 cP to about 19 cP, about 18 cP to about 30 cP, about 19 cP to about 28 cP, about 20 cP to about 26 cP, or about 21 cP to about 26 cP. In embodiments, the first polyvinyl alcohol copolymer can have a viscosity in a range of about 18 cP to about 30 cP, about 19 cP to about 28 cP, about 20 cP to about 26 cP, or about 21 cP to about 26 cP. In embodiments, the first polyvinyl alcohol copolymer can have a viscosity in a range of about 21 cP to about 26 cP. In embodiments, the second polyvinyl alcohol copolymer can have a viscosity in a range of about 10 cP to about 30 cP, for example, about 12 cP to about 28 cP, about 14 cP to about 26 cP, about 16 cP to about 24 cP, or about 18 cP to about 22 cP. In embodiments, the polyvinyl alcohol copolymer can have a viscosity in a range of about 18 cP to about 22 cP.

In embodiments, the polyvinyl alcohol homopolymers and copolymers of the films of the disclosure can have a degree of hydrolysis in a range of about 70% to about 99%. In embodiments, the first polyvinyl alcohol homopolymer, the second polyvinyl alcohol homopolymer, or both can have a degree of hydrolysis in a range of about 70% to about 99%, or about 75% to about 95%, or about 78% to about 90%, or about 80% to about 90% or about 85% to about 90%. In embodiments, the first polyvinyl alcohol homopolymer, the second polyvinyl alcohol homopolymer, or both can have a degree of hydrolysis in a range of about 85% to about 90% or about 86% to about 89%.

The degree of hydrolysis of a resin blend can also be characterized by the arithmetic weighted, average degree of hydrolysis (H̅°̅). For example, H̅°̅ for a PVOH resin that comprises two or more PVOH polymers is calculated by the formula H̅°̅=Σ(Wi·Hᵢ), where Wᵢ is the weight percentage of the respective PVOH polymer and Hᵢ is the respective degree of hydrolysis. In embodiments, the degree of hydrolysis of the polyvinyl alcohol resin, including a blend of two or more polyvinyl alcohol homopolymers, copolymers, or mixture thereof can be in a range of about 70% to about 99%, or about 75% to about 95%, or about 78% to about 90%, or about 80% to about 90% or about 85% to about 90%.

In embodiments wherein the water-soluble film includes a first polyvinyl alcohol homopolymer and a second polyvinyl alcohol homopolymer, the first and second polyvinyl alcohol homopolymers can generally be included in the polyvinyl alcohol resin blend in any suitable ratio. In embodiments, the first polyvinyl alcohol homopolymer can be included in the polyvinyl alcohol resin in an amount in a range of about 60% to about 85%, for example, in a range of about 65% to about 80%, or about 70% to about 80%, such as 60%, 65%, 70%, 75%, or 80%, by weight, based on the total weight of polyvinyl alcohol polymers in the resin. In embodiments, the second polyvinyl alcohol homopolymer can be included in the polyvinyl alcohol resin in an amount in a range of about 15% to about 40%, for examples in a range of about 15% to about 35%, or about 20% to about 30%, such as 15%, 20%, 25%, 30%, 35%, or 40%, by weight, based on the total weight of polyvinyl alcohol polymers in the resin. In embodiments, the first polyvinyl alcohol can be included in the polyvinyl alcohol resin in an amount in a range of about 65% to about 85%, or about 70% to about 80%, by weight, based on the total weight of polyvinyl alcohol polymers in the resin, and the second polyvinyl alcohol homopolymer can make up the balance of the polyvinyl alcohol polymers in the resin.

Without intending to be bound by theory, it is believed that as the relative amount of the second, lower viscosity, polyvinyl alcohol homopolymer in the polyvinyl alcohol resin decreases, the seal strength of the film by solvent sealing decreases and as the relative amount of the second polyvinyl alcohol homopolymer in the polyvinyl alcohol resin increases, the temperature window at which the film can be processed (e.g., by thermoforming) decreases.

In embodiments wherein the water-soluble film includes a polyvinyl alcohol homopolymer and a polyvinyl alcohol copolymer, the polyvinyl alcohol homopolymer and copolymer can generally be included in the polyvinyl alcohol resin blend in any suitable ratio. In embodiments, the polyvinyl alcohol homopolymer can be included in the polyvinyl alcohol resin in an amount in a range of about 25% to about 75%, for example, in a range of about 30% to about 70%, about 35% to about 65%, about 40% to about 60%, or about 45% to about 55%, such as 30%, 40%, 50%, 60%, or 70%, by weight, based on the total weight of polyvinyl alcohol polymers in the resin. In embodiments, the polyvinyl alcohol copolymer can be included in the polyvinyl alcohol resin in an amount in a range of about 75% to about 25%, for examples in a range of about 30% to about 70%, about 35% to about 65%, about 40% to about 60%, or about 45% to about 55%, such as 30%, 40%, 50%, 60%, or 70%, by weight, based on the total weight of polyvinyl alcohol polymers in the resin. In embodiments, the polyvinyl alcohol homopolymer can be included in the polyvinyl alcohol resin in an amount in a range of about 40% to about 60%, or about 45% to about 55%, by weight, based on the total weight of polyvinyl alcohol polymers in the resin, and the polyvinyl alcohol copolymer can make up the balance of the polyvinyl alcohol polymers in the resin.

In embodiments wherein the water-soluble film includes a first polyvinyl alcohol copolymer and a second polyvinyl alcohol copolymer, the first and second polyvinyl alcohol copolymers can generally be included in the polyvinyl alcohol resin blend in any suitable ratio. In embodiments, the first polyvinyl alcohol copolymer can be included in the polyvinyl alcohol resin in an amount in a range of about 1% to about 50%, for example, in a range of about 5% to about 50%, about 10% to about 50%, about 15% to about 45%, about 20% to about 40%, about 40% to about 50%, or about 20% to about 30% such as 20%, 25%, 30%, 40%, or 50%, by weight, based on the total weight of polyvinyl alcohol polymers in the resin. In embodiments, the second polyvinyl alcohol copolymer can be included in the polyvinyl alcohol resin in an amount in a range of about 50% to about 99%, for examples in a range of about 50% to about 90%, about 50% to about 80%, about 50% to about 60%, about 60% to about 80%, or about 70% to about 80%, such as 50%, 60%, 70%, 75%, or 80%, by weight, based on the total weight of polyvinyl alcohol polymers in the resin. In embodiments, the first polyvinyl alcohol copolymer can be included in the polyvinyl alcohol resin in an amount in a range of about 40% to about 50%, or about 20% to about 30%, by weight, based on the total weight of polyvinyl alcohol polymers in the resin, and the polyvinyl alcohol copolymer can make up the balance of the polyvinyl alcohol polymers in the resin.

### Plasticizers

The water-soluble films of the disclosure generally include a plasticizer. A plasticizer is a liquid, solid, or semi-solid that is added to a material (usually a resin or elastomer) making that material softer, more flexible (by decreasing the glass-transition temperature of the polymer), and easier to process. At low plasticizer levels, films may become brittle, difficult to process, or prone to breaking. At elevated plasticizer levels, films may be too soft, weak, or difficult to process for a desired use. Water is recognized as a very efficient plasticizer for PVOH and other polymers; including but not limited to water-soluble polymers, however, the volatility of water makes its utility limited as polymer films need to have at least some resistance (robustness) to a variety of ambient conditions including low and high relative humidity.

The water-soluble films of the disclosure further include a plasticizer. The plasticizer can include, but is not limited to, glycerol, diglycerol, sorbitol, ethylene glycol, diethylene glycol, triethylene glycol, dipropylene glycol, tetraethylene glycol, propylene glycol, polyethylene glycols up to 400 MW, neopentyl glycol, trimethylolpropane (TMP), polyether polyols, 2-methyl-1,3-propanediol (e.g. MP Diol®), ethanolamines, and mixtures thereof. In some embodiments, the plasticizer is selected from glycerol, diglycerol, propylene glycol, ethylene glycol, diethylene glycol, dipropylene glycol, polyethylene glycols up to MW 400, sorbitol, 2-methyl-1,3-propanediol, trimethylolpropane, polyether polyols, and combinations of the foregoing. In one type of embodiment, the plasticizer is selected from the group of sorbitol, glycerol, propylene glycol, 2-methyl-1,3-propanediol, trimethylolpropane, dipropylene glycol, and a combination thereof. In one type of embodiment, the plasticizer is selected from glycerol, propylene glycol, sorbitol, 2-methyl-1,3-propanediol and combinations of the foregoing. In another type of embodiment, the plasticizer includes glycerol, sorbitol, or a combination of the foregoing. In one type of embodiment, the plasticizer is selected from the group of triethylene glycol, sorbitol, glycerol, diglycerin, ethylene glycol, diethylene glycol, dipropylene glycol, tetraethylene glycol, propylene glycol, polyethylene glycols up to 400 Da molecular weight, hexylene glycol, xylitol, 2-methyl-1,3, propanediol, ethanolamines, or a combination thereof. In one type of embodiment, the plasticizer comprises triethylene glycol, polyethylene glycol having a molecular weight of about 200 Da, sorbitol, glycerol, or a combination thereof.

The total amount of the non-water plasticizer can be in a range of about 10 to about 35 weight parts per one hundred parts PVOH resin (PHR), or about 15 to about 35 PHR, or about 15 to about 30 PHR, or about 15 to about 28 PHR, or about 17 PHR to about 25 PHR, or about 18 PHR to about 23 PHR, for example, about 19 PHR, about 20 PHR, about 21 PHR, about 21 PHR, or about 23 PHR. In embodiments, the plasticizer can be provided in an amount in a range of about 15 to about 30 PHR, about 15 to about 28 PHR, about 18 to about 25 PHR, or about 18 to about 23 PHR. In embodiments, the plasticizer can comprise sorbitol, glycerol, or a combination thereof, and can be provided in a range of about 18 to about 23 PHR.

### Surfactants

Surfactants for use in water-soluble films are well known in the art. Optionally, surfactants are included to aid in the dispersion of the resin solution upon casting. Suitable surfactants for water-soluble films of the present disclosure include, but are not limited to, dialkyl sulfosuccinates, lactylated fatty acid esters of glycerol and propylene glycol, lactylic esters of fatty acids, sodium alkyl sulfates, polysorbate 20, polysorbate 60, polysorbate 65, polysorbate 80, alkyl polyethylene glycol ethers, lecithin, acetylated fatty acid esters of glycerol and propylene glycol, sodium lauryl sulfate, acetylated esters of fatty acids, myristyl dimethylamine oxide, trimethyl tallow alkyl ammonium chloride, quaternary ammonium compounds, alkali metal salts of higher fatty acids containing about 8 to 24 carbon atoms, alkyl sulfates, alkyl polyethoxylate sulfates, alkylbenzene sulfonates, monoethanolamine, lauryl alcohol ethoxylate, propylene glycol, diethylene glycol, salts thereof and combinations of any of the forgoing.

Suitable surfactants can include the nonionic, cationic, anionic and zwitterionic classes. Suitable surfactants include, but are not limited to, propylene glycols, diethylene glycols, monoethanolamine, polyoxyethylenated polyoxypropylene glycols, alcohol ethoxylates, alkylphenol ethoxylates, tertiary acetylenic glycols and alkanolamides (nonionics), polyoxyethylenated amines, quaternary ammonium salts and quaternized polyoxyethylenated amines (cationics), alkali metal salts of higher fatty acids containing about 8 to 24 carbon atoms, alkyl sulfates, alkyl polyethoxylate sulfates and alkylbenzene sulfonates (anionics), and amine oxides, N-alkylbetaines and sulfobetaines (zwitterionics). Other suitable surfactants include dioctyl sodium sulfosuccinate, lactylated fatty acid esters of glycerin and propylene glycol, lactylic esters of fatty acids, sodium alkyl sulfates, polysorbate 20, polysorbate 60, polysorbate 65, polysorbate 80, lecithin, acetylated fatty acid esters of glycerin and propylene glycol, and acetylated esters of fatty acids, and combinations thereof. In various embodiments, the amount of surfactant in the water-soluble film is in a range of about 0.1 wt % to 2.5 wt %, optionally about 1.0 wt % to 2.0 wt %. In embodiments, the amount of surfactant in the water-soluble film is expressed in parts per 100 parts total water-soluble polymer (phr) in the water-soluble film and is present in a range of about 0.5 phr to about 4 phr, about 0.75 phr to about 3.0 phr, about 1.0 phr to about 2.5 phr, about 1.0 phr to about 2.0 phr, or about 1.5 phr.

Surfactants can be characterized in terms of hydrophilic/lipophilic balance (HLB). Griffin's method was described in 1954 (Griffin WC: “Calculation of HLB Values of Non-Ionic Surfactants,” Journal of the Society of Cosmetic Chemists 5 (1954): 259) and is used in the art for determining HLB values for non-ionic surfactants as follows: HLB=20*Mh/M, where Mh is the molecular mass of the hydrophilic portion of the molecule, and M is the molecular mass of the whole molecule, giving an HLB value on a scale of 0 to 20. An HLB value of 0 corresponds to a completely lipophilic/hydrophobic molecule and a value of 20 corresponds to a completely hydrophilic/lipophobic molecule.

The water-soluble film can contain other auxiliary agents and processing agents, such as, but not limited to, lubricants, release agents, fillers, extenders, cross-linking agents, antiblocking agents, antioxidants, detackifying agents, antifoams (defoamers), nanoparticles such as layered silicate-type nanoclays (e.g., sodium montmorillonite), bleaching agents (e.g., sodium metabisulfite, sodium bisulfite or others), aversive agents such as bitterants (e.g., denatonium salts such as denatonium benzoate, denatonium saccharide, and denatonium chloride; sucrose octaacetate; quinine; flavonoids such as quercetin and naringen; and quassinoids such as quassin and brucine) and pungents (e.g., capsaicin, piperine, allyl isothiocyanate, and resinferatoxin), and other functional ingredients, in amounts suitable for their intended purposes.

Suitable fillers/extenders/detackifying agents include, but are not limited to, starches, modified starches, crosslinked polyvinylpyrrolidone, crosslinked cellulose, and microcrystalline cellulose. Preferred materials are starches and modified starches. When included in the water-soluble film, the starch and/or modified starch, can be provided in a range of about 0.2 PHR to about 6 PHR, about 0.2 PHR to about 5.0 PHR, about 0.2 to about 4.0 PHR, about 0.2 PHR to about 3.0 PHR, about 0.2 PHR to about 1.0 PHR, or about 0.2 PHR to about 0.9 PHR, or about 0.2 PHR to about 0.8 PHR, or about 0.2 PHR to about 0.7 PHR, or about 0.4 PHR to about 0.7 PHR, or about 0.5 PHR to about 0.7 PHR for example, less than about 1 PHR, less than about 0.9 PHR, or less than about 0.7 PHR. Without intending to be bound by theory, it is believed that fillers, such as starch, are provided within the matrix of the polyvinyl alcohol polymers and reinforce the film as well as help maintain the plasticizers within the film matrix. Further, without intending to be bound by theory, it is believed that as the amount of starch in the film decreases, the tendency of the plasticizers to migrate to the film surface increases and as the amount of starch in the film increases, the tendency of the film to “stress whiten” or increase in opacity upon stretching of the film increases.

An antiblocking agent (e.g., fumed silica, SiO₂, silicate based materials such as talc and hydrosilicates) when present in the film, can be present in the film in a range of about 0.1 to 0.5 PHR, or about 0.1 to about 0.4 PHR, or about 0.1 to 0.3 PHR. In some embodiments, the films can be substantially free of an antiblocking agent. In some embodiments, the films can be substantially free of silica, silicates, and/or SiO₂. As used herein, and unless stated otherwise, “substantially free of an antiblocking agent” refers to films having an antiblocking agent present in an amount of less than about 500 ppm. For example, less than about 400 ppm, less than about 300 ppm, less than about 200 ppm, or less than about 100 ppm. As used herein, and unless stated otherwise, “substantially free of silica, silicates, and/or SiO₂” refers to films having silica, silicates, and/or SiO₂ present in an amount of less than about 500 ppm. For example, less than about 400 ppm, less than about 300 ppm, less than about 200 ppm, or less than about 100 ppm. Without intending to be bound by theory, it is believed that the antiblocking agents phase separate to the surface of a film, providing irregularities on the surface and providing space between layers of film to allow the layers of film to slide past one another.

In a first aspect of the disclosure, the water-soluble film of the disclosure can include a polyvinyl alcohol resin comprising a first polyvinyl alcohol homopolymer having a viscosity in a range of about 16 cP to about 35 cP, about 18 cP to about 27 cP, or about 20 cP to about 25 cP, and a second polyvinyl alcohol homopolymer having a viscosity in a range of about 5 cP to about 15 cP, about 10 cP to about 15 cP, or about 5 cP to about 7 cP, wherein the first polyvinyl alcohol homopolymer is present in an amount in a range of about 60% to about 85% by weight, about 65% to about 85%, or about 70% to 80% by weight, based on the total weight of the polyvinyl alcohol resin and the second polyvinyl alcohol homopolymer is present in an amount in a range of about 15% to about 40% by weight, about 15% to about 35%, or about 20% to about 30% by weight, based on the total weight of the polyvinyl alcohol resin, a plasticizer present in an amount in a range of about 15 to about 35 PHR, and a starch present in an amount in a range of about 0.2 to about 6.0 PHR, about 0.2 to about 3 PHR, or about 0.2 to about 1 PHR and the water-soluble film can be characterized by a matte-to-gloss coefficient of friction of less than 3, for example, less than 1.5, less than 1, or less than 0.6 and a haze at 100% strain in a range of 0.5-40%, 0.5-30%, or 0.5-20%. In embodiments of the first aspect, the water-soluble film of the disclosure can include a polyvinyl alcohol resin comprising a first polyvinyl alcohol homopolymer having a viscosity in a range of about 20 cP to about 25 cP and a second polyvinyl alcohol homopolymer having a viscosity in a range of about 5 cP to about 7 cP, wherein the first polyvinyl alcohol homopolymer is present in an amount in a range of about 70% to about 80% by weight, based on the total weight of the polyvinyl alcohol resin and the second polyvinyl alcohol homopolymer is present in an amount in a range of about 20% to about 30% by weight, based on the total weight of the polyvinyl alcohol resin, a plasticizer present in an amount in a range of about 18 to about 23 PHR, and a starch present in a range of about 0.5 PHR to about 0.7 PHR. In embodiments of the first aspect, the water-soluble film of the disclosure can include a polyvinyl alcohol resin comprising a first polyvinyl alcohol homopolymer having a viscosity in a range of about 16 cP to about 35 cP and a second polyvinyl alcohol homopolymer having a viscosity in a range of about 5 cP to about 15 cP, wherein the first polyvinyl alcohol homopolymer is present in an amount in a range of about 60% to about 85% by weight, based on the total weight of the polyvinyl alcohol resin and the second polyvinyl alcohol homopolymer is present in an amount in a range of about 15% to about 40% by weight, based on the total weight of the polyvinyl alcohol resin, a plasticizer present in an amount in a range of about 15 to about 35 PHR, and a starch present in an amount in a range of about 0.2 to about 1.0 PHR. In embodiments of the first aspect, the water-soluble film of the disclosure can include a polyvinyl alcohol resin comprising a first polyvinyl alcohol homopolymer having a viscosity in a range of about 20 cP to about 25 cP and a second polyvinyl alcohol homopolymer having a viscosity in a range of about 5 cP to about 7 cP, wherein the first polyvinyl alcohol homopolymer is present in an amount in a range of about 70% to about 80% by weight, based on the total weight of the polyvinyl alcohol resin and the second polyvinyl alcohol homopolymer is present in an amount in a range of about 20% to about 30% by weight, based on the total weight of the polyvinyl alcohol resin, a plasticizer present in an amount in a range of about 15 to about 35 PHR, and a starch present in an amount in a range of about 0.2 to about 6.0 PHR and the film can be characterized by a matte-to-gloss coefficient of friction of less than 0.6 and a haze at 100% strain in a range of 0.5-30%. In a refinement of the foregoing embodiment, the water-soluble film can be further characterized by an elongation at break between about 300% to about 350%. In embodiments of the first aspect, the water-soluble film of the disclosure can include a polyvinyl alcohol resin comprising a first polyvinyl alcohol homopolymer having a viscosity in a range of about 20 cP to about 25 cP and a second polyvinyl alcohol homopolymer having a viscosity in a range of about 5 cP to about 7 cP, wherein the first polyvinyl alcohol homopolymer is present in an amount in a range of about 70% to about 80% by weight, based on the total weight of the polyvinyl alcohol resin and the second polyvinyl alcohol homopolymer is present in an amount in a range of about 20% to about 30% by weight, based on the total weight of the polyvinyl alcohol resin, a plasticizer present in an amount in a range of about 15 to about 35 PHR, and a starch present in an amount in a range of about 0.2 to about 3.0 PHR and the film can be characterized by a matte-to-gloss coefficient of friction of less than 0.6 and a haze at 100% strain in a range of 0.5-20%. In refinements of the embodiments of the first aspect, the water-soluble film is substantially free of silica and/or SiO₂. In further refinements of the foregoing embodiments, the water-soluble film is substantially free of an antiblocking agent.

In a second aspect, the disclosure provides a water-soluble film including a water-soluble mixture of a polyvinyl alcohol resin including a polyvinyl alcohol homopolymer having a viscosity in a range of about 5 cP to about 35 cP, about 5 cP to about 15 cP, about 10 cP to about 15 cP, about 5 cP to about 7 cP, about 18 cP to about 27 cP, or about 20 cP to about 5 cP, and a polyvinyl alcohol copolymer having an anionic monomer unit, wherein the polyvinyl alcohol homopolymer is present in an amount in a range of about 25% to about 75% by weight, for example, about 30% to about 70%, about 40% to about 60%, or about 45% to about 55% by weight, based on the total weight of the polyvinyl alcohol resin and the polyvinyl alcohol copolymer is present in an amount in a range of about 75% to about 25% by weight, for examples, about 30% to about 70%, about 40% to about 60%, or about 45% to about 55% by weight, based on the total weight of the polyvinyl alcohol resin, a starch present in an amount in a range of about 0.2 to about 6.0 part by weight based on 100 parts polyvinyl alcohol resin (PHR), about 0.2 PHR to about 3.0 PHR, or about 0.2 PHR to about 1.0 PHR, and a plasticizer present in an amount in a range of about 15 to about 35 PHR, and the water-soluble film is characterized by a matte to gloss coefficient of friction (COF) in a range of about 3.0 or less as determined according to the Coefficient of Friction Test, about 1.5 or less, about 1.0 or less, or about 0.60 or less; and a haze at 100% strain in a range of about 0.5% to about 40%, about 0.5 to about 30%, about 0.5 to about 20%, or about 0.5 to about 20%, as determined according to the Haze Test.

In embodiments of the second aspect, the water-soluble film of the disclosure can include a polyvinyl alcohol homopolymer having a viscosity in a range of about 5 cP to about 7 cP, and a polyvinyl alcohol copolymer including a methyl acrylate monomer unit, wherein the polyvinyl alcohol homopolymer is present in an amount in a range of about 45% to about 55% by weight, based on the total weight of the polyvinyl alcohol resin and the polyvinyl alcohol copolymer is present in an amount in a range of about 55% to about 45% by weight, based on the total weight of the polyvinyl alcohol resin, a starch present in an amount in a range of about 0.2 to about 1.0 part by weight based on 100 parts polyvinyl alcohol resin (PHR), and a plasticizer present in an amount in a range of about 15 to about 35 PHR, and the water-soluble film is characterized by a matte to gloss coefficient of friction (COF) in a range of 0.60 or less; and a haze at 100% strain in a range of about 0.5% to about 40%, as determined according to the Haze Test. In refinements of the foregoing embodiment, the film can be further characterized by an elongation at break in a range of 300 to 350%.

In embodiments of the second aspect, the water-soluble film of the disclosure can include a polyvinyl alcohol homopolymer having a viscosity in a range of about 20 cP to about 26 cP, and a polyvinyl alcohol copolymer including a methyl acrylate monomer unit, wherein the polyvinyl alcohol homopolymer is present in an amount in a range of about about 45% to about 55% by weight, based on the total weight of the polyvinyl alcohol resin and the polyvinyl alcohol copolymer is present in an amount in a range of about 55% to about 45% by weight, based on the total weight of the polyvinyl alcohol resin, a starch present in an amount in a range of about 0.2 to about 1.0 part by weight based on 100 parts polyvinyl alcohol resin (PHR), and a plasticizer present in an amount in a range of about 15 to about 35 PHR, and the water-soluble film is characterized by a matte to gloss coefficient of friction (COF) in a range of 0.60 or less; and a haze at 100% strain in a range of about 0.5% to about 40%, as determined according to the Haze Test.

In a third aspect, the disclosure provides a water-soluble film including a water-soluble mixture of a polyvinyl alcohol resin including a first polyvinyl alcohol copolymer including an anionic monomer unit, and a second polyvinyl alcohol copolymer having an anionic monomer unit, wherein the first polyvinyl alcohol copolymer is present in an amount in a range of about 1% to about 50% by weight, for example, about 20% to about 30%, about 20% to about 40%, about 20% to about 50%, about 30% to about 50%, or about 40% to about 50% by weight, based on the total weight of the polyvinyl alcohol resin and the second polyvinyl alcohol copolymer is present in an amount in a range of about 50% to about 99% by weight, for examples, about 50% to about 80%, about 50% to about 70%, about 50% to about 60% by weight, about 60% to about 80%, or about 70% to about 80% based on the total weight of the polyvinyl alcohol resin, a starch present in an amount in a range of about 0.2 to about 3.0 part by weight based on 100 parts polyvinyl alcohol resin (PHR), or about 0.2 PHR to about 1.0 PHR, and a plasticizer present in an amount in a range of about 15 to about 35 PHR, and the water-soluble film is characterized by a matte to gloss coefficient of friction (COF) in a range of about 3.0 or less as determined according to the Coefficient of Friction Test, about 1.5 or less, about 1.0 or less, or about 0.60 or less; and a haze at 100% strain in a range of about 0.5% to about 40%, about 0.5 to about 30%, about 0.5 to about 20%, or about 0.5 to about 20%, as determined according to the Haze Test.

In embodiments of the third aspect, the water-soluble film can include a first polyvinyl alcohol copolymer including a maleate monomer unit and a second polyvinyl alcohol copolymer including a methyl acrylate monomer unit, wherein the first polyvinyl alcohol copolymer is present in an amount in a range of about 40% to about 50% by weight, based on the total weight of the polyvinyl alcohol resin and the second polyvinyl alcohol copolymer is present in an amount in a range of about 50% to about 60% by weight, based on the total weight of the polyvinyl alcohol resin, a starch present in an amount in a range of about 0.2 to about 1.0 part by weight based on 100 parts polyvinyl alcohol resin (PHR), and a plasticizer present in an amount in a range of about 15 to about 35 PHR, and the water-soluble film is characterized by a matte to gloss coefficient of friction (COF) in a range of about 0.60 or less as determined according to the Coefficient of Friction Test, and a haze at 100% strain in a range of about 0.5% to about 30%, as determined according to the Haze Test. In refinements of the foregoing aspect, the water-soluble film is further characterized by a tensile strength in a range of 40-50 mPa.

In embodiments of the third aspect, the water-soluble film can include a first polyvinyl alcohol copolymer including a maleate monomer unit and a second polyvinyl alcohol copolymer including a methyl acrylate monomer unit, wherein the first polyvinyl alcohol copolymer is present in an amount in a range of about 20% to about 30% by weight, based on the total weight of the polyvinyl alcohol resin and the second polyvinyl alcohol copolymer is present in an amount in a range of about 70% to about 80% by weight, based on the total weight of the polyvinyl alcohol resin, a starch present in an amount in a range of about 0.2 to about 1.0 part by weight based on 100 parts polyvinyl alcohol resin (PHR), and a plasticizer present in an amount in a range of about 15 to about 35 PHR, and the water-soluble film is characterized by a matte to gloss coefficient of friction (COF) in a range of about 0.60 or less as determined according to the Coefficient of Friction Test, and a haze at 100% strain in a range of about 0.5% to about 20%, as determined according to the Haze Test. In refinements of the foregoing aspect, the water-soluble film is further characterized by a tensile strength in a range of 40-50 mPa.

As shown in the examples, below, it was unexpectedly and advantageously found that when the films prepared according to the methods of the disclosure included a blend of two polyvinyl alcohol homopolymers, the films demonstrated less than 40% haze at 100% strain, even when up to 6 phr starch was included, demonstrated a matte-to-gloss static coefficient of friction of less than 0.6 even though the homopolymer that made up the majority of the blend (60-85% by weight of the blend) when used alone provided a film having a matte-to-gloss coefficient of friction of greater than 1, and the haze of the film could be tailored to be less than 20% at 100% strain (about 13%), even when including a resin that when used alone provides a film having a significant higher haze value (about 30%).

Further, as shown in the examples, below, it was surprisingly found that when the films prepared according to methods of the disclosure included a blend of a low viscosity polyvinyl alcohol homopolymer and a polyvinyl alcohol copolymer including a methyl acrylate monomer unit, the films demonstrated a matte-to-gloss static coefficient of friction of less than 6 and a haze of less than 40% at 100% strain and less than 30% for an unstretched film. Instead, it was expected that such a film including a polyvinyl alcohol copolymer including a methyl acrylate monomer unit would have significantly higher haze values in view of a commercial film including this polyvinyl alcohol copolymer having a haze value of about 67% when unstretched. Indeed, by comparing the haze values for Film 2 of the examples with the haze values for the commercial film (Film C3), it can be seen that preparing the films according to the methods of the disclosure can contribute to an increase in clarity of the film, relative to the commercial process. Although Film 2 included less starch than the commercial film (about 0.67 phr relative to about 3.4 phr), it is expected that increasing the amount of starch in Film 2 up to about 6 phr would not significantly increase the haze value (expect less than about 40% at 100% strain, similar to Films 14 and 15) which is still substantially less than the 67% haze in an unstretched state demonstrated by the commercial film.

Further, as shown in the examples, below, it was surprisingly found that when the films prepared according to methods of the disclosure included a blend of a first polyvinyl alcohol copolymer including a maleate monomer unit and a second polyvinyl alcohol copolymer including a methyl acrylate monomer unit, the films demonstrated a matte-to-gloss static coefficient of friction of less than 6 and a haze of less than 30% at 100% strain and less than 20% for an unstretched film. As described above, it was expected that such a film including a polyvinyl alcohol copolymer including a methyl acrylate monomer unit would have significantly higher haze values in view of a commercial film including this polyvinyl alcohol copolymer having a haze value of about 67% when unstretched.

The water-soluble film can further have a residual moisture content of at least 4 wt. %, for example in a range of about 4 to about 10 wt. %, as measured by Karl Fischer titration.

### Methods of Making Film

One contemplated class of embodiments is characterized by the water-soluble film being formed by solvent casting. Processes for solvent casting of PVOH are well-known in the art. For example, in the film-forming process, the polyvinyl alcohol resin(s), plasticizers, and other additives are dissolved in a solvent, typically water, and heated until homogenous. The solution is maintained at elevated temperatures (but not boiling) until suspended gases are released. The solution is then metered onto a surface, allowed to substantially dry (or force-dried) to form a cast film, and then the resulting cast film is removed from the casting surface and wound into a rolled good. The process can be performed batchwise, and is more efficiently performed in a continuous process.

In the formation of continuous films of polyvinyl alcohol, it is the conventional practice to meter a solution of the solution onto a moving casting surface, for example, a continuously moving metal belt, causing the solvent to be substantially removed from the liquid, whereby a self-supporting cast film is formed, and then stripping the resulting cast film from the casting surface and wound into a rolled good.

Optionally, the water-soluble film can be a free-standing film consisting of one layer or a plurality of like layers.

The methods of preparing films of the disclosure generally include solution casting onto a surface a mixture comprising a first polyvinyl alcohol homopolymer, a second polyvinyl alcohol homopolymer, plasticizer, starch, and optional additives of the disclosure in the amounts described herein for each ingredient, wherein the surface is characterized by a gloss unit (GU) value at an angle of 60° of at least about 150. In embodiments, the surface is characterized by a GU value at 60° in a range of about 150 to about 550. In embodiments, the surface can be characterized by a GU value at 60° of at least about 200, at least about 250, at least about 300, at least about 350, at least about 400, or at least about 450. The gloss unit value at 60° can be determined using a gloss meter according to any method known in the art, for example, ASTM D2457-21. A surface having a gloss unit value of at least about 150 can generally be obtained using any suitable method. For example, a casting surface having a gloss unit value of less than about 150 can be polished to achieve a higher gloss value such as about 150, about 200, about 300, about 400, or about 450. Without intending to be bound by theory, it is believed that as the gloss value of the surface increases beyond above about 550 GU, the decrease in haze at 100% strain and the increase in clarity is not significant relative to the values demonstrated for the same film cast on a 550 GU surface.

In solution casting of water-soluble films it is conventional practice to apply a release coating to the casting surface to aid in the removing of the cast film from the casting surface. In embodiments of the methods of the disclosure wherein a release coating is applied to the casting surface and the casting surface is polished to obtain a gloss value of at least 150, the release coating is applied to the surface after polishing of the surface. The release coating can generally be applied to the surface prior to or concurrently with metering the casting solution onto the casting surface.

As shown in the examples, below, the methods of the disclosure advantageously provide films having low haze values (less than 40%, less than 30%, or less than 20%) at 100% strain, for all resin types, even when including starch up to about 6 phr. This result is surprising in view of commercial films using the same resins having high haze values in an unstretched state (68% for Film C1 and 67% for Film C3) and at 100% strain (95% for Film C1). The examples demonstrate that haze can be improved by preparing commercial films according to the methods of the disclosure (Table 3, Film C1 haze improved to 25% when unstretched and 44% at 100% strain). It is believed that the haze could be further improved by casting on a higher gloss surface than that used in Example 3, or reducing the amount of starch to less than 6 phr. For example, as shown in Table 5, when a film is prepared using the same resins as Film C1, less than 40% haze at 100% strain can be achieved for films including 6 phr starch or less. Further, as shown in Table 5, films including the same resin as Film C3 (which demonstrated 67% haze in an unstretched state), could be prepared to demonstrate less than 40% haze at 100% strain (Films 2, 4, 5, 6, and 7).

### Film Characteristics

In embodiments, the water-soluble films of the disclosure can be characterized by a haze value at 100% strain of about 70% or less, for example, in a range of about 0.5% to about 70%, about 0.5% to about 60%, about 0.5% to about 50%, about 5% to about 45%, about 5% to about 40%, about 5% to about 35%, about 10% to about 30%, about 10% to about 25%, about 10% to about 20%, or about 10% to about 15% as determined according to the Haze Test disclosed herein. Without intending to be bound by theory, it is believed that the haze value is representative of how smooth, or rough, a water-soluble film surface is, for example, as the surface roughness of the film increases, the haze value increases due to the scattering of light off of the imperfections in the surface.

In embodiments, the water-soluble films of the disclosure can be characterized by a matte to gloss (M-G) static coefficient of friction of about 5 or less, or about 0.01 to about 5, about 0.05 to about 5, about 0.05 to about 4, about 0.05 to about 3, about 0.05 to about 2, about 0.05 to about 1, about 0.05 to about 0.90, about 0.05 to about 0.80, about 0.05 to about 0.70, about 0.05 to about 0.65, about 0.05 to about 0.60, or about 0.05 to about 0.55, as determined by the Coefficient of Friction Test described herein. The gloss side of a water-soluble film refers to the air side of a water-soluble film cast onto a casting surface. The matte side of a water-soluble film refers to casting surface side of a water-soluble film cast onto a casting surface. The lower the M-G static coefficient of friction, the less likely the film (or pouch formed therefrom) is to stick to the surface on which it is formed (or converted into, e.g., pouches) and/or to other water-soluble films. As used herein, “gloss to gloss static coefficient of friction” refers to the static coefficient of friction between the gloss sides of two water-soluble films having the same formulation. As used herein, “gloss to matte static coefficient of friction” refers to the static coefficient of friction between a gloss side and a matte side of two water-soluble films having the same formulation. As used herein, “matte to matte static coefficient of friction” refers to the static coefficient of friction between the matte sides of two water-soluble films having the same formulation. The gloss to gloss static coefficient of friction is typically higher than the gloss to matte static coefficient of friction and the matte to matte coefficient of friction for a given cast water-soluble film. Without intending to be bound by theory, it is believed that the gloss to gloss static coefficient of friction of a cast film is representative of the static coefficient of friction of a blown film having the same film formulation as the cast film, as blown films are not cast onto a casting surface and, therefore, all sides of a blown film can be considered air or “gloss” sides. Further, the matte to gloss static coefficient of friction is representative of the ease of unrolling a sheet of polyvinyl alcohol film from a roll, wherein the gloss side is in contact with the matte side. In embodiments, the water-soluble films of the disclosure can be characterized by a gloss to gloss coefficient of friction in a range of about 0.05 to about 0.60, about 0.05 to about 0.50, about 0.05 to about 0.40, or about 0.05 to about 0.30 as determined according to the Coefficient of Friction Test.

It is generally understood in the art that when a polymer solution is deposited on a hard substrate for casting, it will adopt some of the surface characteristics of the substrate as the polymer solution settles onto the substrate. Without intending to be bound by theory, it is believed that the surface properties of a cast film can dramatically affect the processing of the film, particularly in a rolled good where the layers are in close contact. Further without intending to be bound by theory, it is generally believed that the smoother the surface of the film, the more surface area that is in contact between the layers and thus the more likely it is that the film can stick to itself on the roll as there are few protrusions/roughness on the surface of the film to keep the layers from sticking.

Surprisingly and advantageously, the films of the disclosure having low haze values of less than about 70%, for example, about less than 60%, about less than 50%, about less than 40%, about less than 30%, or about less than 20% can also have low matte to gloss coefficient of friction values, for example, less than about 1, less than about 0.9, less than about 0.8, less than about 0.7, or less than about 0.6. Such combination of advantageous low haze values and advantageous low coefficient of frication values was surprising because of the understanding in the art that clarity and the coefficient of friction are competing properties. However, it was advantageously found that when the film formulations of the disclosure were cast onto smooth surfaces, not only did the haze value of the film decrease, but the films also demonstrated lower matte to gloss coefficient of friction values.

In embodiments, the water-soluble films can also be characterized by blocking force. Blocking refers to the force required to separate one film layer from another film layer on a roll. Blocking is related to coefficient of friction, in that at high matte to gloss coefficients of friction, a film is more likely to demonstrate high blocking force. In embodiments, the water-soluble films of the disclosure can be characterized by a blocking force for a full roll in a range of about 0.5 N to about 3 N, as determined by the blocking test herein, for example, about 3 N or less, about 2.9 N or less, about 2.8 N or less, about 2.7 N or less, or about 2.6 N or less.

In embodiments, the water soluble film can also be characterized by elongation at break and/or a tensile strength. Elongation at break and tensile strength are generally representative of the mechanical properties of the water-soluble film and the ability of the film to withstand processing. Without intending to be bound by theory, it is believed that as the elongation at break value decreases, the ability to wind the film to a roll under tension decreases and as the elongation at break value increases, the ease of converting the film (e.g., to a pouch) increases. In general, as the amount of plasticizer in the film increases, elongation at break values increase, but the likelihood of blocking increases. In embodiments, the water-soluble films of the disclosure can be characterized by an elongation at break of at least 300% as determined by the Elongation Test, for example, at least 325%, or at least 350% and up to 700%, for example, in a range of 300% to 700%. Without intending to be bound by theory, it is believed that the tensile strength represents how much abuse a film can withstand before failure during processing, for example, when peeled off of the casting surface. In embodiments, the water-soluble films of the disclosure can be characterized by a tensile strength of at least 40 MPa as determined by the Tensile Test, for example, at least 45 MPa, or at least 50 MPa.

In some embodiments, the disclosure provides a water-soluble film including a first polyvinyl alcohol homopolymer characterized by a viscosity of about 20 cP to about 25 cP and a degree of hydrolysis of about 85% to about 95% and a second polyvinyl alcohol homopolymer characterized by a viscosity of about 4 cP to about 8 cP and a degree of hydrolysis of about 85% to about 95%, wherein the first polyvinyl alcohol homopolymer makes up about 65% to about 90% of the total polyvinyl alcohol polymers and the second polyvinyl alcohol homopolymer makes up the balance, and wherein the water-soluble film further includes a starch in an amount in a range of 0 PHR to about 1 PHR and plasticizer in an amount in a range of about 18 PHR to about 23 PHR, wherein the plasticizer comprises sorbitol and glycerol, and the water-soluble film is characterized by a matte to gloss coefficient of friction in a range of about 0.05 to about 0.55, a haze at 100% strain in a range of about 0.5% to about 20%, an elongation at break of at least 350%, and a blocking force fora full roll of less than 3.

### Water-Soluble Articles

The films of the disclosure are useful for creating articles and/or pouches for containing various compositions. The composition contained in the pouch may take any form such as powders, gels, pastes, liquids, tablets or any combination thereof. The film of the disclosure forms at least one side wall of the article and/or pouch, optionally the entire article and/or pouch, and preferably an outer surface of the at least one sidewall.

The film described herein can also be used to make an article and/or pouch with two or more compartments made of the same film or in combination with films of other polymeric materials. In one type of embodiment, the polymers, copolymers or derivatives thereof suitable for use as the additional film are selected from polyvinyl alcohols (i.e., homopolymers and/or copolymers), polyvinyl pyrrolidone, polyalkylene oxides, polyacrylic acid, cellulose, cellulose ethers, cellulose esters, cellulose amides, polyvinyl acetates, polycarboxylic acids and salts, polyaminoacids or peptides, polyamides, polyacrylamide, copolymers of maleic/acrylic acids, polysaccharides including starch and gelatin, natural gums such as xanthan, and carrageenans. For example, polymers can be selected from polyacrylates and water-soluble acrylate copolymers, methylcellulose, carboxymethylcellulose sodium, dextrin, ethylcellulose, hydroxyethyl cellulose, hydroxypropyl methylcellulose, maltodextrin, polymethacrylates, and combinations thereof, or selected from polyvinyl alcohols, polyvinyl alcohol copolymers and hydroxypropyl methyl cellulose (HPMC), and combinations thereof. One contemplated class of embodiments is characterized by the level of polymer in the packet material, for example the PVOH copolymer described above, as described above, being at least 60%.

The articles and/or pouches of the present disclosure can include at least one sealed compartment. Thus, the articles and/or pouches may comprise a single compartment or multiple compartments. A water-soluble pouch or sachet can be formed from two layers of water-soluble polymer film sealed at an interface, or by a single film that is folded upon itself and sealed. One or both of the films include the PVOH film described above. The films define an interior article and/or pouch container volume which contains any desired composition for release into an aqueous environment.

The pouch container volume is not particularly limiting. The pouch container volume, in one type of embodiment is 25 mL or less. In another embodiment, the volume is less than 25 mL. The pouch container volume, in another type, is less than 50 mL.

The composition for use in the pouch is not particularly limited. In embodiments comprising multiple compartments, each compartment may contain identical and/or different compositions. In turn, the compositions may take any suitable form including, but not limited to liquid, solid and combinations thereof (e.g. a solid suspended in a liquid). In some embodiments, the pouches comprise a first, second and third compartment, each of which respectively contains a different first, second, and third composition. Liquid detergents are particularly contemplated.

The compartments of multi-compartment articles and/or pouches may be of the same or different size(s) and/or volume(s). The compartments of the present multi-compartment articles and/or pouches can be separate or conjoined in any suitable manner. In some embodiments, the second and/or third and/or subsequent compartments are superimposed on the first compartment. In one embodiment, the third compartment may be superimposed on the second compartment, which is in turn superimposed on the first compartment in a sandwich configuration. Alternatively, the second and third compartments may be superimposed on the first compartment. However, it is also equally envisaged that the first, second and optionally third and subsequent compartments may be attached to one another in a side by side relationship. The compartments may be packed in a string, each compartment being individually separable by a perforation line. Hence each compartment may be individually torn-off from the remainder of the string by the end-user, for example, so as to pre-treat or post-treat a fabric with a composition from a compartment. In some embodiments, the first compartment may be surrounded by at least the second compartment, for example in a tire-and-rim configuration, or in a pouch-in-a-pouch configuration.

The articles and/or pouches of the present disclosure may comprise one or more different films. For example, in single compartment embodiments, the packet may be made from one wall that is folded onto itself and sealed at the edges, or alternatively, two walls that are sealed together at the edges. In multiple compartment embodiments, the article and/or packet may be made from one or more films such that any given packet compartment may comprise walls made from a single film or multiple films having differing compositions. In one embodiment, a multi-compartment article and/or pouch comprises at least three walls: an outer upper wall; an outer lower wall; and a partitioning wall. The outer upper wall and the outer lower wall are generally opposing and form the exterior of the article and/or pouch. The partitioning wall is interior to the article and/or pouch and is secured to the generally opposing outer walls along a seal line. The partitioning wall separates the interior of the multi-compartment article and/or pouch into at least a first compartment and a second compartment.

In one embodiment, the single compartment or plurality of sealed compartments contains a composition. The plurality of compartments may each contain the same or a different composition. The composition is selected from a liquid, solid or combination thereof.

In embodiments, the disclosure provides a unit dose article comprising at least one compartment and optionally a composition housed in the compartment, wherein at least one wall of the compartment comprises a water-soluble film of the disclosure.

Article and/or Pouch Contents

The present articles (e.g., in the form of pouches or packets) may contain various compositions, for example household care compositions and other composition for non-household care composition, such as agricultural composition and water treatment compositions. A multi-compartment pouch may contain the same or different compositions in each separate compartment. The composition is proximal to the water-soluble film. The composition may be less than about 10 cm, or less than about 5 cm, or less than about 1 cm from the film. Typically the composition is adjacent to the film or in contact with the film. The film may be in the form of a pouch or a compartment, containing the composition therein.

Non-limiting examples of useful compositions (e.g., household care compositions) include light duty and heavy duty liquid detergent compositions, hard surface cleaning compositions, detergent gels commonly used for laundry, bleach and laundry additives, fabric enhancer compositions (such as fabric softeners), shampoos, body washes, and other personal care compositions. Compositions of use in the present pouches may take the form of a liquid, solid or a powder. Liquid compositions may comprise a solid. Solids may include powder or agglomerates, such as micro-capsules, beads, noodles or one or more pearlized balls or mixtures thereof. Such a solid element may provide a technical benefit, through the wash or as a pre-treat, delayed or sequential release component; additionally or alternatively, it may provide an aesthetic effect.

Non-limiting examples of other useful compositions (e.g., non-household care compositions) include agricultural compositions, aviation compositions, food and nutritive compositions, industrial compositions, livestock compositions, marine compositions, medical compositions, mercantile compositions, military and quasi-military compositions, office compositions, and recreational and park compositions, pet compositions, water-treatment compositions, including cleaning and detergent compositions applicable to any such use while excluding fabric and household care compositions. Compositions of use in the present pouches may take the form of a liquid, solid or a powder. Liquid compositions may comprise a solid. Solids may include powder or agglomerates, such as micro-capsules, beads, noodles or one or more pearlized balls or mixtures thereof. Such a solid element may provide a technical benefit, through the wash or as a pre-treat, delayed or sequential release component; additionally or alternatively, it may provide an aesthetic effect.

The compositions encapsulated by the films described herein can have any suitable viscosity depending on factors such as formulated ingredients and purpose of the composition. In one embodiment, the composition has a high shear viscosity value, at a shear rate of 20 s⁻¹ and a temperature of 20° C., of 100 to 3,000 cP, alternatively 300 to 2,000 cP, alternatively 500 to 1,000 cP, and a low shear viscosity value, at a shear rate of 1 s⁻¹ and a temperature of 20° C., of 500 to 100,000 cP, alternatively 1000 to 10,000 cP, alternatively 1,300 to 5,000 cP. Methods to measure viscosity are known in the art. According to the present disclosure, shear viscosity measurements of compositions other than PVOH polymer solutions are carried out using a rotational rheometer e.g. TA instruments AR550. The instrument includes a 40 mm 2° or 1° cone fixture with a gap of around 50-60 μm for isotropic liquids, or a 40 mm flat steel plate with a gap of 1000 μm for particles containing liquids. The measurement is carried out using a flow procedure that contains a conditioning step, a peak hold and a continuous ramp step. The conditioning step involves the setting of the measurement temperature at 20° C., a pre-shear of 10 seconds at a shear rate of 10 s⁻¹, and an equilibration of 60 seconds at the selected temperature. The peak hold involves applying a shear rate of 0.05 s⁻¹ at 20° C. for 3 min with sampling every 10 s. The continuous ramp step is performed at a shear rate from 0.1 to 1200 s⁻¹ for 3 min at 20° C. to obtain the full flow profile.

As described above, the composition may be a non-household care composition. For example, a non-household care composition can be selected from agricultural compositions, aviation compositions, food and nutritive compositions, industrial compositions, building and construction compositions, livestock compositions, marine compositions, medical compositions, mercantile compositions, military and quasi-military compositions, office compositions, and recreational and park compositions, pet compositions, water-treatment compositions, including cleaning and detergent compositions applicable to any such use while excluding fabric and household care compositions.

In one type of embodiment, the composition can include an agrochemical, e.g. one or more insecticides, fungicides, herbicides, pesticides, miticides, repellants, attractants, defoliaments, plant growth regulators, fertilizers, bactericides, micronutrients, and trace elements. Suitable agrochemicals and secondary agents are described in U.S. Pat. Nos. 6,204,223 and 4,681,228 and EP 0989803 A1. For example, suitable herbicides include paraquat salts (for example paraquat dichloride or paraquat bis(methylsulphate), diquat salts (for example diquat dibromide or diquat alginate), and glyphosate or a salt or ester thereof (such as glyphosate isopropylammonium, glyphosate sesquisodium or glyphosate trimesium, also known as sulfosate). Incompatible pairs of crop protection chemicals can be used in separate chambers, for example as described in U.S. Pat. No. 5,558,228. Incompatible pairs of crop protection chemicals that can be used include, for example, bensulfuron methyl and molinate; 2,4-D and thifensulfuron methyl; 2,4-D and methyl 2-[[[[N-4-methoxy-6-methyl-1,3,5-triazine-2-yl)-N-methylamino]carbonyl]amino]-sulfonyl]benzoate; 2,4-D and metsulfuron methyl; maneb or mancozeb and benomyl; glyphosate and metsulfuron methyl; tralomethrin and any organophosphate such as monocrotophos or dimethoate; bromoxynil and N-[[4,6-dimethoxypyrimidine-2-yl)-amino]carbonyl]-3-(ethylsulfonyl)-2-pyridine-sulfonamide; bromoxynil and methyl 2-[[[[(4-methyl-6-methoxy)-1,3,5-triazin-2-yl)amino]carbonyl]amino]sulfonyl]-benzoate; bromoxynil and methyl 2-[[[[N-(4-methoxy-6-methyl-1,3,5-triazin-2-yl)-N-methylamino]carbonyl]amino]-sulfonyl]benzoate. In another, related, type of embodiment, the composition can include one or more seeds, optionally together with soil, and further optionally together with one or more additional components selected from mulch, sand, peat moss, water jelly crystals, and fertilizers, e.g. including types of embodiments described in U.S. Pat. No. 8,333,033.

In another type of embodiment, the composition is a water-treatment agent. Such agents include aggressive oxidizing chemicals, e.g. as described in U.S. Patent Application Publication No. 2014/0110301 and U.S. Pat. No. 8,728,593. For example, sanitizing agents can include hypochlorite salts such as sodium hypochlorite, calcium hypochlorite, and lithium hypochlorite; chlorinated isocyanurates such as dichloroisocyanuric acid (also referred to as “dichlor” or dichloro-s-triazinetrione, 1,3-dichloro-1,3,5-triazinane-2,4,6-trione) and trichloroisocyanuric acid (also referred to as “trichlor” or 1,3,5-trichloro-1,3,5-triazinane-2,4,6-trione). Salts and hydrates of the sanitizing compounds are also contemplated. For example, dichloroisocyanuric acid may be provided as sodium dichloroisocyanurate, sodium dichloroisocyanurate acid dihydrate, among others. Bromine containing sanitizing agents may also be suitable for use in unit dose packaging applications, such as 1,3-dibromo-5,5-dimethylhydantoin (DBDMH), 2,2-dibromo-3-nitrilopropionamide (DBNPA), dibromocyano acetic acid amide, 1-bromo-3-chloro-5,5-dimethylhydantoin; and 2-bromo-2-nitro-1,3-propanediol, among others. The oxidizing agent can be one described in U.S. Pat. No. 7,476,325, e.g. potassium hydrogen peroxymonosulfate. The composition can be a pH-adjusting chemical, e.g. as described in U.S. Patent Application Publication No. 2008/0185347, and can include, for example, an acidic component and an alkaline component such that the composition is effervescent when contacted with water, and adjusts the water pH. Suitable ingredients include sodium bicarbonate, sodium bisulfate, potassium hydroxide, sulfamic acid, organic carboxylic acids, sulfonic acids, and potassium dihydrogen phosphate. A buffer blend can include boric acid, sodium carbonate, glycolic acid, and oxone monopersulfate, for example.

A water-treatment agent can be or can include a flocculant, e.g. as described in U.S. Patent Application Publication No. 2014/0124454. The flocculant can include a polymer flocculant, e.g. polyacrylamide, a polyacrylamide copolymer such as an acrylamide copolymers of diallydimethylammonium chloride (DADMAC), dimethylaminoethylacrylate (DMAEA), dimethylaminoethylmethacrylate (DMAEM), 3-methylamidepropyltrimethylammonium chloride (MAPTAC) or acrylic acid; a cationic polyacrylamide; an anionic polyacrylamide; a neutral polyacrylamide; a polyamine; polyvinylamine; polyethylene imine; polydimethyldiallylammonium chloride; poly oxyethylene; polyvinyl alcohol; polyvinyl pyrrolidone; polyacrylic acid; polyphosphoric acid; polystyrene sulfonic acid; or any combination thereof. A flocculant can be selected from chitosan acetate, chitosan lactate, chitosan adipate, chitosan glutamate, chitosan succinate, chitosan malate, chitosan citrate, chitosan fumarate, chitosan hydrochloride, and combinations thereof. The water-treating composition can include a phosphate removing substance, e.g. one or more selected from a zirconium compound, a rare earth lanthanide salt, an aluminum compound, an iron compound, or any combination thereof.

The composition can be a limescale removing composition, e.g. citric or maleic acid or a sulphate salt thereof, or any mixture thereof, e.g. as described in U.S. Patent Application No. 2006/0172910.

Various other types of compositions are contemplated for use in the packets described herein, including particulates, for example down feathers, e.g. as described in U.S. RE29059 E; super absorbent polymers, e.g. as described in U.S. Patent Application Publication Nos. 2004/0144682 and 2006/0173430; pigments and tinters, e.g. as described in U.S. Pat. No. 3,580,390 and U.S. Patent Application Publication No. 2011/0054111; brazing flux (e.g. alkali metal fluoroaluminates, alkali metal fluorosilicates and alkali metal fluorozincates), e.g. as described in U.S. Pat. No. 8,163,104; food items (e.g., coffee powder or dried soup) as described in U.S. Patent Application Publication No. 2007/0003719; and wound dressings, e.g. as described in U.S. Pat. No. 4,466,431.

In pouches comprising laundry, laundry additive and/or fabric enhancer compositions, the compositions may comprise one or more of the following non-limiting list of ingredients: fabric care benefit agent; detersive enzyme; deposition aid; rheology modifier; builder; bleach; bleaching agent; bleach precursor; bleach booster; bleach catalyst; perfume and/or perfume microcapsules (see for example U.S. Pat. No. 5,137,646); perfume loaded zeolite; starch encapsulated accord; polyglycerol esters; whitening agent; pearlescent agent; enzyme stabilizing systems; scavenging agents including fixing agents for anionic dyes, complexing agents for anionic surfactants, and mixtures thereof; optical brighteners or fluorescers; polymer including but not limited to soil release polymer and/or soil suspension polymer; dispersants; antifoam agents; non-aqueous solvent; fatty acid; suds suppressors, e.g., silicone suds suppressors (see: U.S. Publication No. 2003/0060390 A1, ¶65-77); cationic starches (see: US 2004/0204337 A1 and US 2007/0219111 A1); scum dispersants (see: US 2003/0126282 A1, ¶89-90); substantive dyes; hueing dyes (see: US 2014/0162929 A1); colorants; opacifier; antioxidant; hydrotropes such as toluenesulfonates, cumenesulfonates and naphthalenesulfonates; color speckles; colored beads, spheres or extrudates; clay softening agents; anti-bacterial agents. Any one or more of these ingredients is further described in described in U.S. Patent Application Publication Number US 2010/305020 A1, U.S. Publication Number 2003/0139312 A1 and U.S. Patent Application Publication Number US 2011/0023240 A1. Additionally or alternatively, the compositions may comprise surfactants, quaternary ammonium compounds, and/or solvent systems. Quaternary ammonium compounds may be present in fabric enhancer compositions, such as fabric softeners, and comprise quaternary ammonium cations that are positively charged polyatomic ions of the structure NR₄⁺, where R is an alkyl group or an aryl group.

Surfactants

The detergent compositions can comprise from about 1% to 80% by weight of a surfactant. Surfactant is particularly preferred as a component of the first composition. Preferably, the first composition comprises from about 5% to 50% by weight of surfactant. The second and third compositions may comprise surfactant at levels of from 0.1 to 99.9%.

Detersive surfactants utilized can be of the anionic, nonionic, zwitterionic, ampholytic or cationic type or can comprise compatible mixtures of these types. More preferably surfactants are selected from the group consisting of anionic, nonionic, cationic surfactants and mixtures thereof. Preferably the compositions are substantially free of betaine surfactants. Detergent surfactants useful herein are described in U.S. Pat. Nos. 3,664,961; 3,919,678; 4,222,905; and 4,239,659. Anionic and nonionic surfactants are preferred.

Useful anionic surfactants can themselves be of several different types. For example, water-soluble salts of the higher fatty acids, i.e., “soaps”, are useful anionic surfactants in the compositions herein. This includes alkali metal soaps such as the sodium, potassium, ammonium, and alkyl ammonium salts of higher fatty acids containing from about 8 to about 24 carbon atoms, and preferably from about 12 to about 18 carbon atoms. Soaps can be made by direct saponification of fats and oils or by the neutralization of free fatty acids. Particularly useful are the sodium and potassium salts of the mixtures of fatty acids derived from coconut oil and tallow, i.e., sodium or potassium tallow and coconut soap.

Additional non-soap anionic surfactants which are suitable for use herein include the water-soluble salts, preferably the alkali metal, and ammonium salts, of organic sulfuric reaction products having in their molecular structure an alkyl group containing from about 10 to about 20 carbon atoms and a sulfonic acid or sulfuric acid ester group. (Included in the term “alkyl” is the alkyl portion of acyl groups.) Examples of this group of synthetic surfactants include: a) the sodium, potassium and ammonium alkyl sulfates, especially those obtained by sulfating the higher alcohols (C₈-C₁₈) such as those produced by reducing the glycerides of tallow or coconut oil; b) the sodium, potassium and ammonium alkyl polyethoxylate sulfates, particularly those in which the alkyl group contains from 10 to 22, preferably from 12 to 18 carbon atoms, and wherein the polyethoxylate chain contains from 1 to 15, preferably 1 to 6 ethoxylate moieties; and c) the sodium and potassium alkylbenzene sulfonates in which the alkyl group contains from about 9 to about 15 carbon atoms, in straight chain or branched chain configuration, e.g., those of the type described in U.S. Pat. Nos. 2,220,099 and 2,477,383. Especially valuable are linear straight chain alkylbenzene sulfonates in which the average number of carbon atoms in the alkyl group is from about 11 to 13, abbreviated as C₁₁-C₁₃ LAS.

Preferred nonionic surfactants are those of the formula R₁(OC₂H₄)ₙOH, wherein R₁ is a C₁₀-C₁₆ alkyl group or a C₈-C₁₂ alkyl phenyl group, and n is from 3 to about 80. Particularly preferred are condensation products of C₁₂-C₁₅ alcohols with from about 5 to about 20 moles of ethylene oxide per mole of alcohol, e.g., C₁₂-C₁₃ alcohol condensed with about 6.5 moles of ethylene oxide per mole of alcohol.

Solvent System

The solvent system in the detergent compositions can be a solvent system containing water alone or mixtures of organic solvents with water. Preferred organic solvents include 1,2-propanediol, ethanol, glycerin, dipropylene glycol, methyl propane diol and mixtures thereof. Other lower alcohols, low molecular weight polyols, C₁-C₄ alkanolamines such as monoethanolamine and triethanolamine, can also be used. As used herein a “low molecular weight polyol” is a molecule with more than two hydroxyl groups that has a molecular weight in a range of 50 g/mol and 1000 g/mol, 50 g/mol to 800 g/mol, or 50 g/mol to 600 g/mol. Solvent systems can be absent, for example from anhydrous solid detergent embodiments of the disclosure, but more typically are present at levels in the range of from about 0.1% to about 98%, preferably at least about 1% to about 50%, more usually from about 5% to about 25% by weight. Typically, the present detergent compositions, particularly when in liquid form, comprise less than 50% water, preferably from about 0.1% to about 20% water, or more preferably from about 0.5% to about 15%, or from about 3% to about 12%, by weight of the composition, of water. Typically, the present detergent compositions, particularly when in liquid form, comprise from about 5% to about 20% or from about 10% to about 15% glycerin, by weight of the composition. Typically, the present detergent compositions, particularly when in liquid form, comprise less than 30% propylene glycol, for example, from about 0.1% to 25% propylene glycol, 0.5% to 20% propylene glycol, or 5% to 15% propylene glycol, by weight of the composition.

The detergent compositions herein can generally be prepared by mixing the ingredients together. If a pearlescent material is used it should be added in the late stages of mixing. If a rheology modifier is used, it is preferred to first form a pre-mix within which the rheology modifier is dispersed in a portion of the water and optionally other ingredients eventually used to comprise the detergent compositions. This pre-mix is formed in such a way that it forms a structured liquid. To this structured pre-mix can then be added, while the pre-mix is under agitation, the surfactant(s) and essential laundry adjunct materials, along with water and whatever optional detergent composition adjuncts are to be used.

The pH of the detergent compositions may be from about 2 to about 12, about 4 to about 12, about 5.5 to about 9.5, about 6 to about 8.5, or about 6.5 to about 8.2. Laundry detergent compositions may have a pH of about 6 to about 10, about 6.5 to about 8.5, about 7 to about 7.5, or about 8 to about 10. Auto-dishwashing compositions may have a pH of about 8 to about 12. Laundry detergent additive compositions may have a pH of about 4 to about 8. Fabric enhancers may have a pH of from about 2 or 4 to about 8, or from about 2 to about 4, or from about 2.5 to about 3.5, or from about 2.7 to about 3.3.

The pH of the detergent is defined as the pH of an aqueous 10% (weight/volume) solution of the detergent at 20° C.±2° C.; for solids and powdered detergent this is defined as the pH of an aqueous 1% (weight/volume) solution of the detergent at 20° C.±2° C. Any meter capable of measuring pH to ±0.01 pH units is suitable. Orion meters (Thermo Scientific, Clintinpark—Keppekouter, Ninovesteenweg 198, 9320 Erembodegem—Aalst, Belgium) or equivalent are acceptable instruments. The pH meter should be equipped with a suitable glass electrode with calomel or silver/silver chloride reference. An example includes Mettler DB 115. The electrode shall be stored in the manufacturer's recommended electrolyte solution.

The 10% aqueous solution of the detergent is prepared according to the following procedure. A sample of 10±0.05 grams is weighted with a balance capable of accurately measuring to ±0.02 grams. The sample is transferred to a 100 mL volumetric flask, diluted to volume with purified water (deionized and/or distilled water are suitable as long as the conductivity of the water is <5 S/cm), and thoroughly mixed. About 50 mL of the resulting solution is poured into a beaker, the temperature is adjusted to 20° C.±2° C. and the pH is measured according to the standard procedure of the pH meter manufacturer (it is critical to follow the manufacturer's instructions to also set up and calibrate the pH assembly).

For solid and powdered detergents, the 1% aqueous solution of the detergent is prepared according to the following procedure. A sample of 10±0.05 grams is weighted with a balance capable of accurately measuring to ±0.02 grams. The sample is transferred to a volumetric flask of 1000 mL, diluted to volume with purified water (deionized and/or distilled water are suitable as long as the conductivity of the water is <5 S/cm), and thoroughly mixed. About 50 mL of the resulting solution is poured into a beaker, the temperature is adjusted to 20° C.±2° C. and the pH is measured according to the standard procedure of the pH meter manufacturer (it is critical to follow the manufacturer's instructions to also set up and calibrate the pH assembly).

It is known in the art that, when formed into a pouch enclosing a composition, some film components (e.g., plasticizers) can, in some circumstances, migrate from the film into the enclosed composition and, additionally or alternatively, some components of the enclosed composition (e.g., plasticizer, solvent) can migrate into the film. Without intending to be bound by theory, it is believed that this migration of components into/out of the film can result in changes to the films swelling value.

Bleaches

Inorganic and organic bleaches are suitable cleaning actives for use herein. Inorganic bleaches include perhydrate salts such as perborate, percarbonate, perphosphate, persulfate and persilicate salts. The inorganic perhydrate salts are normally the alkali metal salts. The inorganic perhydrate salt may be included as the crystalline solid without additional protection. Alternatively, the salt can be coated as is known in the art.

Alkali metal percarbonates, particularly sodium percarbonate are preferred perhydrates for use in the detergent composition described herein. The percarbonate is most preferably incorporated into the products in a coated form and/or encapsulated, which provides in-product stability. A suitable coating material providing in product stability comprises mixed salt of a water-soluble alkali metal sulphate and carbonate. Such coatings together with coating processes have previously been described in GB 1,466,799, and U.S. Pat. Nos. 3,975,280; 4,075,116; and 5,340,496, each incorporated herein by reference. The weight ratio of the mixed salt coating material to percarbonate lies in the range from 1:99 to 1:9, and preferably from 1:49 to 1:19. Preferably, the mixed salt is of sodium sulphate and sodium carbonate which has the general formula Na₂SO₄nNa₂CO₃ wherein n is from 0.1 to 3, preferably from 0.3 to 1.0, and more preferably from 0.2 to 0.5. Another suitable coating material providing in product stability comprises sodium silicate of SiO₂:Na₂O ratio from 1.8:1 to 3.0:1, preferably 1.8:1 to 2.4:1, and/or sodium metasilicate, preferably applied at a level of from 2% to 10%, (normally from 3% to 5%) of SiO₂ by weight of the inorganic perhydrate salt, such as potassium peroxymonopersulfate. Other coatings which contain magnesium silicate, silicate and borate salts, silicate and boric acids, waxes, oils, and fatty soaps can also be used advantageously

Organic bleaches can include organic peroxyacids including diacyl and tetraacylperoxides, especially diperoxydodecanedioc acid, diperoxytetradecanedioc acid, and diperoxyhexadecanedioc acid. Dibenzoyl peroxide is a preferred organic peroxyacid herein. The diacyl peroxide, especially dibenzoyl peroxide, preferably can be present in the form of particles having a weight average diameter of from about 0.1 to about 100 microns, preferably from about 0.5 to about 30 microns, more preferably from about 1 to about 10 microns. Preferably, at least about 25% to 100%, more preferably at least about 50%, even more preferably at least about 75%, most preferably at least about 90%, of the particles are smaller than 10 microns, preferably smaller than 6 microns.

Other organic bleaches include the peroxy acids, particular examples being the alkylperoxy acids and the arylperoxy acids. Preferred representatives are: (a) peroxybenzoic acid and its ring-substituted derivatives, such as alkylperoxybenzoic acids, but also peroxy-α-naphthoic acid and magnesium monoperphthalate; (b) the aliphatic or substituted aliphatic peroxy acids, such as peroxylauric acid, peroxystearic acid, ε-phthalimidoperoxycaproic acid[phthaloiminoperoxyhexanoic acid (PAP)], o-carboxybenzamidoperoxycaproic acid, N-nonenylamidoperadipic acid and N-nonenylamidopersuccinates; and (c) aliphatic and araliphatic peroxydicarboxylic acids, such as 1,12-diperoxycarboxylic acid, 1,9-diperoxyazelaic acid, diperoxysebacic acid, diperoxybrassylic acid, the diperoxyphthalic acids, 2-decyldiperoxybutane-1,4-dioic acid, N,N-terephthaloyldi(6-aminopercaproic acid)

Bleach activators can include organic peracid precursors that enhance the bleaching action in the course of cleaning at temperatures of 60° C. and below. Bleach activators suitable for use herein include compounds which, under perhydrolysis conditions, give aliphatic peroxoycarboxylic acids having preferably from 1 to 10 carbon atoms, in particular from 2 to 4 carbon atoms, and/or optionally substituted perbenzoic acid. Suitable substances bear O-acyl and/or N-acyl groups of the number of carbon atoms specified and/or optionally substituted benzoyl groups. Preference is given to polyacylated alkylenediamines, in particular tetraacetylethylenediamine (TAED), acylated triazine derivatives, in particular 1,5-diacetyl-2,4-dioxohexahydro-1,3,5-triazine (DADHT), acylated glycolurils, in particular tetraacetylglycoluril (TAGU), N-acylimides, in particular N-nonanoylsuccinimide (NOSI), acylated phenolsulfonates, in particular n-nonanoyl- or isononanoyloxybenzenesulfonate (n- or iso-NOBS), carboxylic anhydrides, in particular phthalic anhydride, acylated polyhydric alcohols, in particular triacetin, ethylene glycol diacetate and 2,5-diacetoxy-2,5-dihydrofuran and also triethylacetyl citrate (TEAC).

Bleach catalysts preferred for use in the detergent composition herein include the manganese triazacyclononane and related complexes (U.S. Pat. Nos. 4,246,612 and 5,227,084); Co, Cu, Mn and Fe bispyridylamine and related complexes (U.S. Pat. No. 5,114,611); and pentamine acetate cobalt(III) and related complexes (U.S. Pat. No. 4,810,410). A complete description of bleach catalysts suitable for use herein can be found in U.S. Pat. No. 6,599,871, incorporated herein by reference.

Dishwashing Agents

A preferred surfactant for use in automatic dishwashing detergents is low foaming by itself or in combination with other components (e.g. suds suppressers). Preferred for use herein are low and high cloud point nonionic surfactants and mixtures thereof including nonionic alkoxylated surfactants (especially ethoxylates derived from C₆-C₁₈ primary alcohols), ethoxylated-propoxylated alcohols (e.g., Olin Corporation's POLY-TERGENT® SLF18), epoxy-capped poly(oxyalkylated) alcohols (e.g., Olin Corporation's POLY-TERGENT® SLF18B—see WO-A-94/22800), ether-capped poly(oxyalkylated) alcohol surfactants, and block polyoxyethylene-polyoxypropylene polymeric compounds such as PLURONIC, REVERSED PLURONIC, and TETRONIC by the BASF-Wyandotte Corp., Wyandotte, Mich.; amphoteric surfactants such as the C₁₂-C₂₀ alkyl amine oxides (preferred amine oxides for use herein include lauryldimethyl amine oxide and hexadecyl dimethyl amine oxide), and alkyl amphocarboxylic surfactants such as MIRANOL™ C2M; and zwitterionic surfactants such as the betaines and sultaines; and mixtures thereof. Surfactants suitable for use herein are disclosed, for example, in U.S. Pat. Nos. 3,929,678 and 4,259,217, EP Patent Publication 0414549A1, and PCT patent application publications WO 1994/007974 A1 and WO 1994/007986 A1. Surfactants can be present in the detergent at a level of from about 0.2% to about 30% by weight, more preferably from about 0.5% to about 10% by weight, most preferably from about 1% to about 5% by weight of a detergent composition.

Other Compositions and Additives

Builders suitable for use in the detergent composition described herein include water-soluble builders, including citrates, carbonates, silicate and polyphosphates, e.g. sodium tripolyphosphate and sodium tripolyphosphate hexahydrate, potassium tripolyphosphate and mixed sodium and potassium tripolyphosphate salts.

Enzymes suitable for use in the detergent composition described herein include bacterial and fungal cellulases including CAREZYME and CELLUZYME (Novo Nordisk A/S); peroxidases; lipases including AMANO-P (Amano Pharmaceutical Co.), M1 LIPASE and LIPOMAX (Gist-Brocades) and LIPOLASE and LIPOLASE ULTRA (Novo); cutinases; proteases including ESPERASE, ALCALASE, DURAZYM and SAVINASE (Novo) and MAXATASE, MAXACAL, PROPERASE and MAXAPEM (Gist-Brocades); and amylases including PURAFECT OX AM (Genencor) and TERMAMYL, BAN, FUNGAMYL, DURAMYL, and NATALASE (Novo); pectinases; and mixtures thereof. Enzymes can be added herein as prills, granulates, or cogranulates at levels typically in the range from about 0.0001% to about 2% pure enzyme by weight of the cleaning composition.

Suds suppressers suitable for use in the detergent composition described herein include nonionic surfactants having a low cloud point. “Cloud point” as used herein, is a well-known property of nonionic surfactants which is the result of the surfactant becoming less soluble with increasing temperature, the temperature at which the appearance of a second phase is observable is referred to as the “cloud point.” As used herein, a “low cloud point” nonionic surfactant is defined as a nonionic surfactant system ingredient having a cloud point of less than 30° C., preferably less than about 20° C., and even more preferably less than about 10° C., and most preferably less than about 7.5° C. Low cloud point nonionic surfactants can include nonionic alkoxylated surfactants, especially ethoxylates derived from primary alcohol, and polyoxypropylene/polyoxyethylene/polyoxypropylene (PO/EO/PO) reverse block polymers. Also, such low cloud point nonionic surfactants can include, for example, ethoxylated-propoxylated alcohol (e.g., BASF POLY-TERGENT SLF18) and epoxy-capped poly(oxyalkylated) alcohols (e.g., BASF POLY-TERGENT SLF18B series of nonionics, as described, for example, in U.S. Pat. No. 5,576,281).

Other suitable components for use in the detergent composition described herein include cleaning polymers having anti-redeposition, soil release or other detergency properties. Anti-redeposition polymers for use herein include acrylic acid containing polymers such as SOKALAN PA30, PA20, PA15, PA10 and SOKALAN CP10 (BASF GmbH), ACUSOL 45N, 480N, 460N (Rohm and Haas), acrylic acid/maleic acid copolymers such as SOKALAN CP5 and acrylic/methacrylic copolymers. Other suitable polymers include amine-based polymers such as alkoxylated polyalkyleneimines (e.g., PEI600 EO20 and/or ethoxysulfated hexamethylene diamine dimethyl quats). Soil release polymers for use herein include alkyl and hydroxyalkyl celluloses (U.S. Pat. No. 4,000,093), polyoxyethylenes, polyoxypropylenes and copolymers thereof, and nonionic and anionic polymers based on terephthalate esters of ethylene glycol, propylene glycol and mixtures thereof.

Heavy metal sequestrants and crystal growth inhibitors are also suitable for use in the detergent, for example diethylenetriamine penta(methylene phosphonate), ethylenediamine tetra(methylene phosphonate) hexamethylenediamine tetra(methylene phosphonate), ethylene diphosphonate, hydroxy-ethylene-1,1-diphosphonate, nitrilotriacetate, ethylenediaminotetracetate, ethylenediamine-N,N′-disuccinate in their salt and free acid forms.

Suitable for use in the detergent composition described herein is also a corrosion inhibitor, for example organic silver coating agents (especially paraffins such as WINOG 70 sold by Wintershall, Salzbergen, Germany), nitrogen-containing corrosion inhibitor compounds (for example benzotriazole and benzimadazole—see GB-A-1137741) and Mn(II) compounds, particularly Mn(II) salts of organic ligands.

Other suitable components for use in the detergent composition herein include enzyme stabilizers, for example calcium ion, boric acid and propylene glycol.

Other suitable components for use in the detergent composition herein include humectants, for example, as described in U.S. Patent Application Publication No. 2015/0329807.

Suitable rinse additives are known in the art. Commercial rinse aids for dishwashing typically are mixtures of low-foaming fatty alcohol polyethylene/polypropylene glycol ethers, solubilizers (for example cumene sulfonate), organic acids (for example citric acid) and solvents (for example ethanol). The function of such rinse aids is to influence the interfacial tension of the water in such a way that it is able to drain from the rinsed surfaces in the form of a thin coherent film, so that no water droplets, streaks, or films are left after the subsequent drying process. European Patent 0 197 434 B1 describes rinse aids which contain mixed ethers as surfactants. Rinse additives such as fabric softeners and the like are also contemplated and suitable for encapsulation in a film according to the disclosure herein.

### Elongation Test and Tensile Test

A film characterized by or to be tested for tensile strength or elongation at break is analyzed as follows. The procedure includes the determination of elongation at break based on ASTM D 882 (“Standard Test Method for Tensile Properties of Thin Plastic Sheeting”) or equivalent. An INSTRON® tensile testing apparatus (Model 5544 Tensile Tester or equivalent) is used for the collection of film data. A minimum of three test specimens, each cut with reliable cutting tools to ensure dimensional stability and reproducibility, are tested in the machine direction (MD) (where applicable) for each measurement. Tests are conducted in the standard laboratory atmosphere of 23±2.0° C. and 35±5% relative humidity after conditioning in the same environment for 24 hours. For tensile strength determination and elongation at break determination, 1″-wide (2.54 cm) samples of a single film sheet having a thickness of 3.0±0.10 mil (or 76.2±2.5 μm) are prepared. The tensile testing machine is prepared according to manufacturer instructions, equipped with a 500 N load cell, and calibrated. The correct grips and faces are fitted (INSTRON® grips having model number 2702-032 faces, which are rubber coated and 25 mm wide, or equivalent). The samples are mounted into the tensile testing machine and analyzed to determine the elongation at break (i.e., where Young's Modulus applies) and/or tensile strength (i.e., stress required to break film).

Suitable behavior of films according to the disclosure is marked by elongation at break of at least about 300%. Suitable behavior of films according to the disclosure is marked by tensile strength values (in the machine direction (MD)) of at least about 40 MPa. In various embodiments, the films of the disclosure can have an elongation at break of about 325%, or at least 350%, and/or a tensile strength of at least in a range of about 40 MPa to about 60 MPa, for example, at least 45 MPa, at least 50 MPa, and/or up to about 55 MPa or up to about 60 MPa.

### Coefficient of Friction Test

Films according to the disclosure characterized by or tested in accordance with the Coefficient of Friction Test can be analyzed as follows. The Coefficient of Friction method tests the friction of two pieces of material that are rubbed against each other; the force required to move one piece against the other is measured. The force to start the sled (static friction) and the force to keep the sled moving (dynamic friction) are both measured by the load cell using ASTM D1894 “Friction Testing of Plastic Film and Sheeting.”

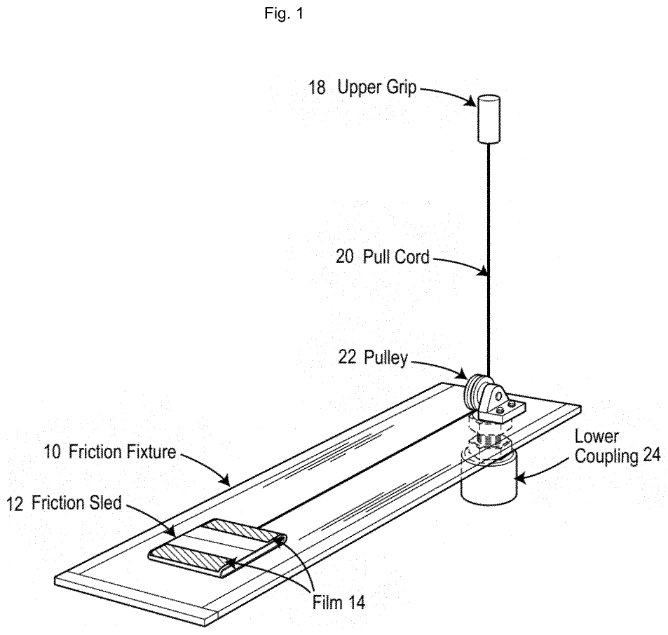

The method uses an Instron® Coefficient of Friction Testing Fixture Model 2810-005, or equivalent, a representative diagram of which is shown in FIG. 1, and an Instron® Testing Machine Model #5543, or equivalent.

The testing apparatus includes a friction fixture 10 upon which rests a friction sled 12 having secured thereon a film sample 14. The sled 12 is coupled to the upper grip 18 via a pull cord 20 which engages with pulley 22 secured to the friction fixture 10. The lower coupling 24 secures the testing fixture to the Instron® testing machine (not shown).

According the Instron® method Blue Hill program: “The system: searches the data from the start value to the end value on the specified channel for the maximum value; determines the first data point that rises and falls by the percentage of the maximum value and assigns this point as the first peak; uses the following equation to determine the coefficient of static friction: static friction=first peak/sled weight; uses the following equation to calculate the average load of the area from the first peak to the end value: average load=energy/change in extension; and uses the following equation to determine the coefficient of dynamic friction: dynamic friction=average load/sled weight.”

The test specimen shall consist of samples having dimensions (5 inch by 5 inch square (12.7 cm by 12.7 cm square) for the sled and 5 inch by 8 inch rectangle (12.7 cm by 20.3 cm) for the surface, to form a testing area. While it is believed that the film thickness will not affect the Static COF, the film can have a thickness of 3.0±0.10 mil (or 76.2±2.5 μm). The samples can be cut using a razor blade and templates of the appropriate dimensions, for example. When applicable, the sample should be cut with the long dimension parallel to the machine direction of the cast film. Again when applicable, the 5 inch×5 inch sample direction should be noted and oriented in the test so that the direction the sled is being pulled is parallel to the machine direction of the film sample.

The test specimen shall be conditioned at 75° F.±5° F. and relative humidity 35%±5% for not less than 8 hours prior to the test, and the test is conducted at the same temperature and relative humidity conditions.

Installation Procedure of COF Apparatus
1. Remove the clevis pin from the lower jaw on the Instron® Coefficient of Friction Testing Fixture Model 2810-005, and remove.
2. Remove the clevis pin from the upper jaw, and remove.
3. Place the friction fixture lower coupling onto the base adapter of the Instron® Testing Machine Model #5543.
4. Fit it with the clevis pin.
5. Slip the loop of one end of the pull cord onto the upper clevis pin, and replace the locking clip.
6. Calibrate Testing Machine Model #5543
7. Slip the loop on the other end of the pull cord onto the friction sled hook.
8. Make sure the pulley is able to spin freely
9. Move the sled till the pull cord has no slack and is oriented in the groove around the pulley.
10. Position the moving crosshead (upper heard) of the Instron® Coefficient of Friction Testing Fixture Model 2810-005 so that there is sufficient travel space to draw the friction sled along the full 50 mm of the test without running the sled into the pulley.
11. Keep the cord taught while the crosshead is moving.
12. Using the JOG control on the Instron #5543 control panel, set the extension limit so that the far end of the friction sled does not exceed the back plane (the plane perpendicular to the axis of motion, and furthest from the pulley) of the friction fixture. Press the GL button to set the travel limit. This prevents the friction sled from colliding with the pulley during the test, and insures that the coefficient of friction of the sample of interest is properly measured.
13. The test fixture is now ready for testing.

Placement of Specimen Procedure
1. Place the surface sample on the aluminum friction fixture in the appropriate orientation.
2. Pull the surface sample tight over the edges of the aluminum surface and tape the sample on the bottom side of the friction fixture.
3. It is important to tape along the end of the friction fixture furthest from the coupling to avoid binding of the sled on the surface.
4. Make sure that the material is taught but not stretched.
5. Wrap the friction sled with the 5×5 inch sample so that the machine direction of the film is parallel to the direction the sled will be pulled.
6. Tape the leading edge overlap on the top of the sled making sure there is no excess material which will bind up on the surface sample.
7. Tape the other edges of the sample on the friction sled to ensure the sample is taught on the contact surface being measured.
8. Be sure that no tape will get between the surface of interest on the sled and on the friction fixture.
9. The samples on the friction surface and on the friction sled should be taught with no wrinkles or bulges; these will cause errors in measuring the COF.
10. Inspect the sled to be sure there are no foreign materials touching the surfaces being tested.
11. Attach the sled to the pull cord and place the sled very lightly and gently on the friction table in order to prevent any unnatural bond from developing between the two specimens, begin test promptly.
12. Be sure that at full extension the sled sits completely over the sample placed on the friction fixture and does not contact tape or hang over the edge of the friction fixture.

Performing the COF Test
1. Test not less than three specimens per requested orientation (example air side-air side or band side-band side).
2. For a combination of air side to band side testing, the air side orientation of the film should be the film sample placed on the aluminum test surface, and the band side for testing should comprise the material wrapped around the sled.
3. Be sure to wear powder-free, moisture barrier gloves while handling the film specimens; powder or moisture may compromise the accuracy of the test.
4. Cut a sample as described above, e.g. using a template.
5. Place the friction sled wrapped in the first specimen at the end of the friction fixture furthest from the pulley.
6. Make sure the pull cord is pulled taught.
7. Open the Coefficient of Friction test titled “COF.im ptf” from the testing screen.
8. Click the start button on the screen to begin the test.
9. Upon completion of the specimen test run, click ok and return the friction sled to the starting position and change the film specimen on the friction sled and the fixture. Repeat the test.

The film can be characterized by a static COF in a range of 4.0 or less, or 2.0 or less, or 1.5 or less, or 1.25 or less, or 1.0 or less, or 0.5 of less, for example 1.0, 0.9, 0.8, 0.7, 0.6, or even less. In another aspect, the static COF can be less than 4.0, or less than about 2.5, or less than 2, or less than 1. In embodiments, the films of the disclosure can be characterized by a matte to gloss static coefficient of friction in a range of about 0.05 to about 1.

### Haze Test

Films of the disclosure characterized by or tested according to the Haze Test can be analyzed as follows. The haze of a film can be measured with a BYK Haze Gard i Benchtop Haze Meter, or equivalent, using the BYK smart-chart software. The absorption and scattering behavior of the transparent specimen will determine how much light will pass through and how objects will appear through the transparent product. Haze is the percentage of light which in passing through the transparent specimen deviates from the incident beam by greater than 2.5 degrees on the average.

BYK Calibration Standard Serial #1306881 is used if calibration is needed. Film samples having a thickness of 3.0±0.10 mil (or 76.2±2.5 μm) are conditioned for 24 hours at about 25° C. and 35% relative humidity. The films are cut into a square having a side length in the range of about 5½ to 6 inches (about 14 cm-15.25 cm). Review the film sample testing area and remove any soil, fingerprints, and abrasions of any kind. The film sample is placed over the top of the smaller, tapered ring of the holder. Then place the larger ring onto the outside of the smaller ring until the film is wrinkle-free and smooth for a haze reading. Any imperfections of the film should be minimized as they can affect how the light transmits through the sample.

Place the film specimen at the haze port. Hit the measurement button and do not move or shift the sample while the indication lamp is flashing. Haze readings are distance dependent, and the film should be flush against the haze port opening.

Take at least three measurements per sample, moving the sample around in the film holder before each reading. The film can be uniaxially stretched prior to testing. In some embodiments, the films are conditioned at 100% strain for at least 1 minute and up to 5 minutes prior to testing. 100% strain refers to uniaxial stretching in the machine direction to twice the film size. Suitable films of the disclosure suitably have a haze value of less than 70%, less than 50%, less than 40%, less than 30%, less than 25%, or less than 20% after being conditioned at 100% strain for 1 minute.

### Blocking Test

Blocking refers to the force required to separate one film layer from another film layer on a roll. In general, as blocking decreases, a film can more easily be unrolled without imparting strain or stretching to the film, or producing tension in a converting process. Blocking force generally tends to increase as the level of plasticizer in a film increases. The blocking test measures the blocking force between layers of film on a roll. The blocking force measurement does not contain any friction force from the outer surface of the roll as it is being unwound.

Films of the disclosure characterized by or tested in accordance with the Blocking Test can be analyzed as follows. Blocking force is measured in Newton's on a digital force meter, or equivalent. Measurements are taken throughout an entire roll of film (4-4.5 inches from the outside edge of the core) having a thickness of 3.0±0.10 mil (or 76.2±2.5 μm) using the force gauge. The roll is placed on a table such that it unwinds from the underneath, away from the technician. The first measurement is taken after removing the top 3 layers of the film from the selected roll. Approximately 3 inches of film is unwound and then the film is folded over itself 3 times to create a 1 inch wide edge. A 1 inch slit is made at the midpoint of the layered edge in the web direction, parallel with roll axis. Place the hook of the force gauge in the slit and measure the force to unwind the roll 3 times. Hold the force gauge so that it is horizontal with the table. While holding the force gauge, push the roll at approximately 1 incher per second, without pulling the force gauge. The peak force is recorded. The roll is then cut approximately half way to the core (2-2.25 inches from the outside edge of the core) and the measurements repeated. The roll is then cut down to 1 inch from the outside edge of the core and the measurements repeated. Finally, the roll is cut down to ⅛ inch from the outside edge of the core and the measurements repeated. Blocking test is completed when 3 peaks force values have been obtained from the full roll, middle of the roll, 1 inch from the core edge, and ⅛ inch from the core edge.

Suitable films generally have a maximum peak force of less than 12.00 N, for example, less than about 10 N, less than about 7.5 N, less than about 5 N, less than about 4 N, or less than about 3 N, obtained from the full roll. In embodiments, films of the disclosure have a maximum peak force obtained from the full roll of about 3 N or less, about 2.9N or less, about 2.8 N or less, about 2.7 N or less, or about 2.6 N or less.

### Dissolution and Disintegration Test MSTM-205

A film can be characterized by or tested for Dissolution Time and Disintegration Time according to the MonoSol Test Method 205 (MSTM 205), a method known in the art. See, for example, U.S. Pat. No. 7,022,656.

### Apparatus and Materials:

### 600 mL Beaker

Magnetic Stirrer (Labline Model No. 1250 or equivalent)

### Magnetic Stirring Rod (5 cm)

### Thermometer (0 to 100° C.±1° C.)

Template, Stainless Steel (3.8 cm×3.2 cm)
Timer (0-300 seconds, accurate to the nearest second)
Polaroid 35 mm slide Mount (or equivalent)
MonoSol 35 mm Slide Mount Holder (or equivalent)
Distilled water

For each film to be tested, three test specimens are cut from a film sample that is a 3.8 cm×3.2 cm specimen. If cut from a film web, specimens should be cut from areas of web evenly spaced along the traverse direction of the web. Each test specimen is then analyzed using the following procedure.

Lock each specimen in a separate 35 mm slide mount.

Fill beaker with 500 mL of distilled water. Measure water temperature with thermometer and, if necessary, heat or cool water to maintain temperature at 20° C. (about 68° F.).

Mark height of column of water. Place magnetic stirrer on base of holder. Place beaker on magnetic stirrer, add magnetic stirring rod to beaker, turn on stirrer, and adjust stir speed until a vortex develops which is approximately one-fifth the height of the water column. Mark depth of vortex.

Secure the 35 mm slide mount in the alligator clamp of the 35 mm slide mount holder such that the long end of the slide mount is parallel to the water surface. The depth adjuster of the holder should be set so that when dropped, the end of the clamp will be 0.6 cm below the surface of the water. One of the short sides of the slide mount should be next to the side of the beaker with the other positioned directly over the center of the stirring rod such that the film surface is perpendicular to the flow of the water.

In one motion, drop the secured slide and clamp into the water and start the timer. Disintegration occurs when the film breaks apart. When all visible film is released from the slide mount, raise the slide out of the water while continuing to monitor the solution for undissolved film fragments. Dissolution occurs when all film fragments are no longer visible and the solution becomes clear.

The results should include the following: complete sample identification; individual and average disintegration and dissolution times; and water temperature at which the samples were tested.

Film disintegration times (I) and film dissolution times (I) can be corrected to a standard or reference film thickness using the exponential algorithms shown below in Equation 1 and Equation 2, respectively.

I_{corrected}=Iₘₑₐₛᵤᵣₑ×(reference thickness/measured thickness)^{1.93} [1]

S_{corrected}=S_{measured}×(reference thickness/measured thickness)^{1.83} [2]

The water-soluble films in accordance with the disclosure can be better understood in light of the following examples, which are merely intended to illustrate the water-soluble films and are not meant to limit the scope thereof in any way.

### EXAMPLES

Various polyvinyl alcohol (PVOH) resins are used in the examples below. The PVOH resins are as follows:

| | | Nominal Degree of | |
|---|---|---|---|
| | Nominal Viscosity | Hydrolysis | co-monomer |
| PVOH-1 | 23 cP | 88% | none |
| PVOH-2 | 6 cP | 88% | none |
| PVOH-3 | 26 cP | 89-93% | maleate |
| PVOH-4 | 20 cP | 99.5% | methyl acrylate |
| PVOH-5 | 18 cP | 88% | none |
| PVOH-6 | 13 cP | 88% | none |
| PVOH-7 | 8 cP | 88% | none |

### Example 1

A water soluble film of the disclosure (Film 1) was prepared in accordance with the methods of the disclosure, as described in Table 1, below. The ingredients were mixed in water, cast on a casting surface having a GU value of 450 at 60°, and dried to a water content in a range of about 4%-8%. The resulting water-soluble films had thicknesses of 3.0±0.10 mil (or 76.2±2.5 μm) and were tested in accordance with the test methods disclosed herein. Three additional commercial films were tested in accordance with the test methods disclosed herein and compared to the film of the invention. The commercial films are described in Table 1, below, as Film C1, Film C2, and Film C3. Commercial film C2 is considered a “clear” film when compared to other commercially available films and commercial film C3 is considered to have low clarity, when compared to other commercially available films.

TABLE 1

| | Film 1 | Film C1 | Film C2 | Film C3 |
|---|---|---|---|---|
| PVOH-1 (wt % total PVOH) | 75 | 75 | | |
| PVOH-2 (wt % total PVOH) | 25 | 25 | | |
| PVOH-3 (wt % total PVOH) | | | 100 | |
| PVOH - 4 (wt % total PVOH) | | | | 100 |
| Starch (PHR) | 0.63 | 25.00 | 2.66 | 3.41 |
| Plasticizer (PHR) | 19.02 | 22.17 | 24.88 | 43.11 |
| Surfactant (PHR) | 1.64 | 2.22 | 0.60 | 2.22 |
| Aversive agent (PHR) | 0.07 | 0.16 | 0.15 | |
| Antifoam (PHR) | | | 0.03 | 0.71 |
| Bleaching agent (PHR) | | | 0.27 | 0.2 |
| Filler | | | | 1.83 |

In Table 2, a film having a matte to gloss static coefficient of friction of less than 0.6 is identified with an “*”, between 0.6 and 3 is identified with a “+”, and greater than 3 with a “−”. In Table 2, a film having a blocking force value for the full roll of less than 3 N is indicated with an “*”, between 3 N and 3.5 N is indicated with a “+”, and greater than 3.5 N is indicated with “−”. In Table 2, a film having an elongation at break of greater than 350% is indicated with an “*”, between 300% and 350% is indicated with a “+”, and less than 300% is indicated with a “−”. In Table 2, a film having a tensile strength of greater than 50 MPa is indicated with a “*”, between 40 MPa and 50 MPa is indicated with a “+”, and less than 40 MPa is indicated with a “−”. In Table 2, a film having a dissolution time of less than 60 seconds is indicated with a “*”, between 60 seconds and 300 seconds is indicated with a “+”, and greater than 300 seconds is indicated with a “−”. In Table 2, a film having a haze at 0% strain of less than 20% is identified with an “*”, between 20% and 50% is identified with a “+”, and greater than 50% with a “−”. In Table 2, a film having a haze at 100% strain of less than 20% is identified with an “*”, between 20% and 40% is identified with a “+”, and greater than 40% with a “−”.

TABLE 2

| | | Haze | Haze | | | | |
|---|---|---|---|---|---|---|---|
| | | at | at | | | | |
| | | 0% | 100% | | Elongation | Tensile | Dissolution |
| | CoF | strain | strain | Blocking | at Break | Strength | Time |
| Film | * | * | * | * | * | * | * |
| 1 | | | | | | | |
| Film | * | − | − | * | + | − | * |
| C1 | | | | | | | |
| Film | + | + | + | − | * | * | * |
| C2 | | | | | | | |
| Film | | − | | | | | |
| C3 | | | | | | | |

Thus, Example 1 shows that films of the disclosure (Film 1) advantageously demonstrate good matte to gloss static coefficients of friction, haze, blocking, elongation at break, and tensile strength, while maintaining good dissolution properties. Example 1 further shows that films according to the disclosure prepared according to methods of the disclosure demonstrate improved coefficient of friction values and clarity relative to commercially available “clear” films (Film C2), and significantly improved clarity over commercially available films prepared from similar polyvinyl alcohol homopolymer resins, without a significant increase in coefficient of friction values.

### Example 2

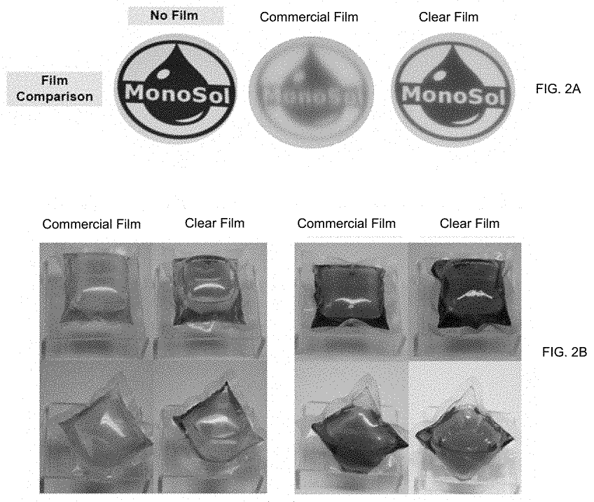

The clarity of the commercially available film “clear” film, Film C2 from Example 1, was compared to Film 1 of Example 1. As shown in FIG. 2A, in a non-stretched state, the film of the disclosure, Film 1, demonstrates significantly improved clarity over the commercial “clear” film. As shown in FIG. 2B, after forming each of the Film C2 and Film 1 into pouches encompassing a colored composition, the film of the disclosure maintained the improvement in clarity over the commercial film.

Accordingly, Example 2 demonstrates advantageous clarity over commercially available “clear” films in both a non-stretched and stretched state.

### Example 3

To compare the properties of a water-soluble film of the disclosure to films representative of commercially available films, but prepared in accordance with the methods of the disclosure, water-soluble films having the formulations disclosed in Table 1 of Example 1 were prepared as follows. The ingredients were mixed in water, cast on a casting surface having a GU value of 200 at 60°, and dried to a water content in a range of about 4%-8%. The resulting water-soluble films had thicknesses of 3.0±0.10 mil (or 76.2±2.5 μm) and were tested in accordance with the test methods disclosed herein. The results are shown in Table 3, below.

In Table 3, a film having a matte to gloss static coefficient of friction of less than 0.6 is identified with an “*”, between 0.6 and 3 is identified with a “+”, and greater than 3 with a “−”. In Table 3, a film having a haze at 0% strain of less than 20% is identified with an “*”, between 20% and 50% is identified with a “+”, and greater than 50% with a “−”. In Table 3, a film having a haze at 100% strain of less than 20% is identified with an “*”, between 20% and 40% is identified with a “+”, and greater than 40% with a “−”.

TABLE 3

| | | Haze at | Haze at |
|---|---|---|---|
| | CoF | 0% Strain | 100% Strain |
| Film 1 | * | * | * |
| Film C1 | * | + | − |

Thus, Example 3 shows that the films of the disclosure outperform a commercially available film, even when both films are cast on a smooth surface. Further, when compared to Example 1, Example 3 shows that the methods of the disclosure can decrease the haze for films having formulations representative of commercial films.

### Example 4

A series of films were prepared and tested for matte to gloss static coefficient of friction, blocking force, elongation at break, tensile strength, dissolution time, and haze. The films were prepared in accordance with the methods of the disclosure, as described in Table 4, below. The ingredients were mixed in water, cast on a casting surface having a GU value of 450 at 60°, and dried to a water content in a range of about 4%-8%. The resulting water-soluble films had thicknesses of 3.0±0.10 mil (or 76.2±2.5 μm) and were tested in accordance with the test methods disclosed herein.

TABLE 4

| | Film #: | | | | | | | | | | | | | | |
|---|---|---|---|---|---|---|---|---|---|---|---|---|---|---|---|
| | 2 | 3 | 4 | 5 | 6 | 7 | 8 | 9 | 10 | 11 | 12 | 13 | 14 | 15 | 16 |
| PVOH-1¹ | | | | | | | | 100 | | | | | 75 | 75 | 75 |
| PVOH-2 | | | | | | 50 | 50 | | | | | 100 | 25 | 25 | 25 |
| PVOH-3 | | 100 | 50 | 25 | 75 | | 50 | | | | | | | | |
| PVOH-4 | 100 | | 50 | 75 | 25 | 50 | | | | | | | | | |
| PVOH-5 | | | | | | | | | 100 | | | | | | |
| PVOH-6 | | | | | | | | | | 100 | | | | | |
| PVOH-7 | | | | | | | | | | | 100 | | | | |
| Starch | 0.63 | 0.63 | 0.63 | 0.63 | 0.63 | 0.63 | 0.63 | 0.63 | 0.63 | 0.63 | 0.63 | 0.63 | 3.00 | 6.00 | 10.63 |
| (PHR) | | | | | | | | | | | | | | | |
| Plasticizer | 19.34 | 19.34 | 19.34 | 19.34 | 19.34 | 19.34 | 19.34 | 19.34 | 19.34 | 19.34 | 19.34 | 19.34 | 19.34 | 19.34 | 15.85 |
| (PHR) | | | | | | | | | | | | | | | |
| Surfactant | 1.64 | 1.64 | 1.64 | 1.64 | 1.64 | 1.64 | 1.64 | 1.64 | 1.64 | 1.64 | 1.64 | 1.64 | 1.64 | 1.64 | 1.64 |
| (PHR) | | | | | | | | | | | | | | | |
| Aversive | 0.08 | 0.08 | 0.08 | 0.08 | 0.08 | 0.08 | 0.08 | 0.08 | 0.08 | 0.08 | 0.08 | 0.08 | 0.08 | 0.08 | 0.08 |
| agent | | | | | | | | | | | | | | | |
| (PHR) | | | | | | | | | | | | | | | |
| Antifoam | | | | | | | | | | | | | | | |
| (PHR) | | | | | | | | | | | | | | | |
| Bleaching | | | | | | | | | | | | | | | |
| agent | | | | | | | | | | | | | | | |
| (PHR) | | | | | | | | | | | | | | | |

¹The amount of PVOH is provided as a wt %, based on the total PVOH in the film.

TABLE 5

| | | Haze at | Haze at | Elongation | Tensile |
|---|---|---|---|---|---|
| | CoF | 0% strain | 100% strain | at Break | Strength |
| Film 2 | * | * | * | − | + |
| Film 3 | * | * | * | − | + |
| Film 4 | * | * | + | − | + |
| Film 5 | * | * | * | − | + |
| Film 6 | − | * | + | * | − |
| Film 7 | * | + | + | + | − |
| Film 8 | − | * | * | + | − |
| Film 9 | + | * | * | + | − |
| Film 10 | − | * | * | + | + |
| Film 11 | − | * | * | − | − |
| Film 12 | − | * | * | + | − |
| Film 13 | + | * | + | * | − |
| Film 14 | * | + | + | + | − |
| Film 15 | * | + | + | + | − |
| Film 16 | + | * | − | − | − |

In Table 5, a film having a matte to gloss static coefficient of friction of less than 0.6 is identified with an “*”, between 0.6 and 3 is identified with a “+”, and greater than 3 with a “−”. In Table 5, a film having an elongation at break of greater than 350% is indicated with an “*”, between 300% and 350% is indicated with a “+”, and less than 300% is indicated with a “−”. In Table 5, a film having a tensile strength of greater than 50 MPa is indicated with a “*”, between 40 MPa and 50 MPa is indicated with a “+”, and less than 40 MPa is indicated with a “−”. “−”. In Table 5, a film having a haze at 0% strain of less than 20% is identified with an “*”, between 20% and 50% is identified with a “+”, and greater than 50% with a “−”. In Table 5, a film having a haze at 100% strain of less than 20% is identified with an “*”, between 20% and 40% is identified with a “+”, and greater than 40% with a “−”.

Thus, Example 4 shows that films prepared according to methods of the disclosure, when cast on a high gloss surface, all films demonstrated good haze (<40% at 100% strain) when including up to 6 phr starch. Further, casting on a high gloss surface does not detrimentally affect the matte-to-gloss static coefficient of friction. Without intending to be bound by theory, it is believed that for Films 10-12, a conformational change in the polymer occurred upon casting and drying which led to higher demonstrated coefficient of friction values. It is further believed that the higher coefficient of friction values could be alleviated by blending these polymers with a polyvinyl alcohol homopolymer having a viscosity in a range of 5-7 cP, 20-25 cP, or a polyvinyl alcohol copolymer having an anionic monomer unit including methyl acrylate. Likewise, for Films 6 and 8, it is believed that a conformation change in the polyvinyl alcohol polymer having an anionic monomer unit including a maleate modification led to higher coefficient of friction values, which could be alleviated by blending with the second polymer in greater proportions, as in Films 4 and 5.

Example 5 also shows that films prepared according to the methods of the disclosure and including a blend of two polyvinyl alcohol homopolymers, the films can advantageously demonstrate less than 40% haze at 100% strain, even when up to 6 phr starch was included, demonstrate a matte-to-gloss static coefficient of friction of less than 0.6 even though the homopolymer that made up the majority of the blend (60-85% by weight of the blend) when used alone provided a film having a matte-to-gloss coefficient of friction of greater than 1 (compare Films 1, 14, and 15 with Film 9), and the haze of the film could be tailored to be less than 20% at 100% strain (about 13%), even when including a resin that when used alone provides a film having a significant higher haze value (about 30%, compare Film 1 with Film 13).

Example 5 further shows that films prepared according to methods of the disclosure and including a blend of a low viscosity polyvinyl alcohol homopolymer and a polyvinyl alcohol copolymer including a methyl acrylate monomer unit, the films demonstrated a matte-to-gloss static coefficient of friction of less than 6 and a haze of less than 40% at 100% strain and less than 30% for an unstretched film. This result was unexpected; instead it was expected that such a film including a polyvinyl alcohol copolymer including a methyl acrylate monomer unit would have significantly higher haze values in view of a commercial film including this polyvinyl alcohol copolymer having a haze value of about 67% when unstretched. Indeed, by comparing the haze values for Film 2 with the haze values for the commercial film (Film C3), it can be seen that preparing the films according to the methods of the disclosure can contribute to an increase in clarity of the film, relative to the commercial process. Although Film 2 included less starch than the commercial film (about 0.67 phr relative to about 3.4 phr), it is expected that increasing the amount of starch in Film 2 up to about 6 phr would not significantly increase the haze value (expect less than about 40% at 100% strain, similar to Films 14 and 15) which is still substantially less than the 67% haze in an unstretched state demonstrated by the commercial film.

Finally, Example 5 shows that when the films prepared according to methods of the disclosure included a blend of a first polyvinyl alcohol copolymer including a maleate monomer unit and a second polyvinyl alcohol copolymer including a methyl acrylate monomer unit, the films demonstrated a matte-to-gloss static coefficient of friction of less than 6 and a haze of less than 30% at 100% strain and less than 20% for an unstretched film. This result was also unexpected in view of the expectation that such a film including a polyvinyl alcohol copolymer including a methyl acrylate monomer unit would have significantly higher haze values in view of a commercial film including this polyvinyl alcohol copolymer having a haze value of about 67% when unstretched.

Because modifications and changes varied to fit particular operating requirements and environments will be apparent to those skilled in the art, the disclosure is not considered limited to the examples chosen for purposes of illustration, and covers all changes and modifications which do not constitute departures from the true spirit and scope of this disclosure.

Accordingly, the foregoing description is given for clearness of understanding only, and no unnecessary limitations should be understood therefrom, as modifications within the scope of the disclosure may be apparent to those having ordinary skill in the art.

Throughout the specification, where the compounds, compositions, articles, methods, and processes are described as including components, steps, or materials, it is contemplated that the compositions, processes, or apparatus can also comprise, consist essentially of, or consist of, any combination of the recited components or materials, unless described otherwise.

1. A water-soluble film comprising:
a water-soluble mixture comprising
a polyvinyl alcohol resin comprising a first polyvinyl alcohol homopolymer having a viscosity in a range of about 16 cP to about 35 cp and a second polyvinyl alcohol homopolymer having a viscosity in a range of about 5 cP to about 15 cP, wherein the first polyvinyl alcohol homopolymer is present in an amount in a range of about 60% to about 85% by weight, based on the total weight of the polyvinyl alcohol resin and the second polyvinyl alcohol homopolymer is present in an amount in a range of about 15% to about 40% by weight, based on the total weight of the polyvinyl alcohol resin;
a starch present in an amount in a range of about 0.2 to about 6.0 parts by weight based on 100 parts polyvinyl alcohol resin (PHR); and
a plasticizer present in an amount in a range of about 15 to about 35 PHR,
wherein the water-soluble film is characterized by a matte to gloss coefficient of friction (COF) in a range of about 0.05 to about 3.0 as determined according to the Coefficient of Friction Test; and a haze at 100% strain in a range of about 0.5% to about 40% as determined according to the Haze Test.

2. The water-soluble film of claim 1, wherein the first polyvinyl alcohol homopolymer is provided in an amount in a range of about 70% to about 80% by weight of the polyvinyl alcohol resin with the balance being the second polyvinyl alcohol homopolymer.

3. The water-soluble film of claim 1, wherein the first polyvinyl alcohol homopolymer has a viscosity in a range of about 18 cP to about 35 cP, about 18 cP to about 30 cP, about 18 cP to about 27 cP, about 18 cP to about 55 cP, or about 20 cP to about 25 cP.

4. The water-soluble film of claim 2, wherein the first polyvinyl alcohol homopolymer has a viscosity in a range of about 20 to 25 cP.

5. The water-soluble film of claim 1, wherein the first polyvinyl alcohol homopolymer and/or the second polyvinyl alcohol homopolymer has a degree of hydrolysis in a range of about 70% to about 99%, or about 75% to about 95%, or about 78% to about 90%, or about 80% to about 90% or about 85% to about 90%.

6. The water-soluble film of claim 1, wherein the water-soluble film is characterized by a matte to gloss static coefficient of friction (COF) in a range of about 0.05 to about 1.0, about 0.05 to about 0.90, about 0.05 to about 0.80, about 0.05 to about 0.75, about 0.05 to about 0.07, about 0.05 to about 0.65, about 0.05 to about 0.60, or about 0.05 to about 0.55 as determined according to the Coefficient of Friction Test.

7. The water-soluble film of claim 1, wherein the water-soluble film is characterized by a gloss to gloss static coefficient of friction in a range of about 0.05 to about 0.60, about 0.05 to about 0.50, about 0.05 to about 0.40, or about 0.05 to about 0.30 as determined according to the Coefficient of Friction Test.

8. The water-soluble film of claim 1, wherein the water-soluble film is characterized by a haze at 100% strain in a range of about 0.5% to about 30%, about 5% to about 30%, about 5% to about 25%, about 10% to about 25%, about 10% to about 20%, or about 10% to about 15% as determined according to the Haze Test.

9. The water-soluble film of claim 1, wherein the film is characterized by elongation at break of at least 300% as determined by the Elongation Test, for example, at least 325%, or at least 350%.

10. The water-soluble film of claim 1, wherein the film is characterized by a tensile strength of at least 40 MPa, at least 45 MPa, or at least 50 MPa as determined by the Tensile Test.

11. The water-soluble film of claim 1, wherein the film is characterized by a blocking force for a full roll of about 3 N or less as determined by the Blocking Test, or about 2.9 N or less, or about 2.8 N or less, or about 2.7 N or less, or about 2.6 N or less, or in a range of about 0.5 N to about 3 N.

12. The water-soluble film of claim 1, the starch is provided in an amount in a range of about 0.2 PHR to about 5 PHR, about 0.2 PHR to about 4 PHR, about 0.2 PHR to about 3 PHR, about 0.2 PHR to about 2 PHR, about 0.2 PHR to about 1 PHR, about 0.2 PHR to about 0.9 PHR, about 0.2 PHR to about 0.8 PHR, about 0.3 PHR to about 0.7 PHR, about 0.4 PHR to about 0.7 PHR, or about 0.5 PHR to about 0.7 PHR.

13. The water-soluble film of claim 1, wherein the plasticizer is provided in an amount in a range of about 15 to about 30 PHR, about 15 to about 28 PHR, about 17 to about 25 PHR, about 18 to about 23 PHR, for example, about 19 PHR, about 20 PHR, about 21 PHR, about 22 PHR, or about 23 PHR.

14. The water-soluble film of claim 13, wherein the plasticizer comprises triethylene glycol, sorbitol, glycerol, diglycerin, ethylene glycol, diethylene glycol, dipropylene glycol, tetraethylene glycol, propylene glycol, polyethylene glycols up to 400 Da molecular weight, hexylene glycol, xylitol, 2-methyl-1,3, propanediol, ethanolamines, or a combination thereof.

15. The water-soluble film of any one of claim 2, wherein the first polyvinyl alcohol homopolymer is characterized by a viscosity of about 20 cP to about 25 cP and a degree of hydrolysis of about 85% to about 95%; the second polyvinyl alcohol homopolymer is characterized by a viscosity of about 4 cP to about 8 cP and a degree of hydrolysis of about 85% to about 95%; the first polyvinyl alcohol homopolymer makes up about 65% to about 90% of the total polyvinyl alcohol polymers and the second polyvinyl alcohol homopolymer makes up the balance; the water-soluble film further comprises a starch in an amount in a range of 0.2 PHR to about 1.0 PHR and a plasticizer in an amount in a range of about 18 PHR to about 23 PHR and the plasticizer comprises sorbitol and glycerol; and the water-soluble film is characterized by a matte to gloss coefficient of friction in a range of about 0.05 to about 0.55, a haze at 100% strain in a range of about 0.5% to about 20%, an elongation at break of at least about 350%, and a blocking value for a full roll of less than 3.

16. The water-soluble film of claim 1, wherein the water-soluble film is substantially free of an antiblocking agent.

17. A water-soluble article comprising:
a water-soluble film comprising
a polyvinyl alcohol resin comprising a first polyvinyl alcohol homopolymer having a viscosity in a range of about 16 cP to about 35 cp and a second polyvinyl alcohol homopolymer having a viscosity in a range of about 5 cP to about 7 cP, wherein the first polyvinyl alcohol homopolymer is present in an amount in a range of about 60% to about 85% by weight, based on the total weight of the polyvinyl alcohol resin and the second polyvinyl alcohol homopolymer is present in an amount in a range of about 15% to about 40% by weight, based on the total weight of the polyvinyl alcohol resin;
a starch present in an amount in a range of about 0.2 to about 6.0 parts by weight based on 100 parts polyvinyl alcohol resin (PHR); and
a plasticizer present in an amount in a range of about 15 to about 35 PHR,
wherein the water-soluble film is characterized by a matte to gloss coefficient of friction (COF) in a range of about 0.05 to about 3.0 as determined according to the Coefficient of Friction Test; and a haze at 100% strain in a range of about 0.5% to about 40% as determined according to the Haze Test.

18. A water-soluble unit dose article comprising at least one compartment and optionally a composition housed in the compartment, wherein the unit dose article comprises a water-soluble film comprising:
a polyvinyl alcohol resin comprising a first polyvinyl alcohol homopolymer having a viscosity in a range of about 16 cP to about 35 cp and a second polyvinyl alcohol homopolymer having a viscosity in a range of about 5 cP to about 7 cP, wherein the first polyvinyl alcohol homopolymer is present in an amount in a range of about 60% to about 85% by weight, based on the total weight of the polyvinyl alcohol resin and the second polyvinyl alcohol homopolymer is present in an amount in a range of about 15% to about 40% by weight, based on the total weight of the polyvinyl alcohol resin;
a starch present in an amount in a range of about 0.2 to about 6.0 parts by weight based on 100 parts polyvinyl alcohol resin (PHR); and
a plasticizer present in an amount in a range of about 15 to about 35 PHR,
wherein the water-soluble film is characterized by a matte to gloss coefficient of friction (COF) in a range of about 0.05 to about 3.0 as determined according to the Coefficient of Friction Test; and a haze at 100% strain in a range of about 0.5% to about 40% as determined according to the Haze Test.

19. A method of preparing a water-soluble film according to claim 1, the method comprising:
casting onto a surface a mixture comprising a first polyvinyl alcohol homopolymer, wherein the surface is characterized by a gloss unit (GU) value at an angle of 60° of at least about 150.

20. The method of claim 19, wherein the surface is characterized by a GU value at an angle of 60° of at least about 200, at least about 250, at least about 300, at least about 350, at least about 400, or at least about 450.

21. The water-soluble film of claim 1, wherein the second polyvinyl alcohol homopolymer has a viscosity in a range of 5 cP to 7 cP.
